(19) United States
(12) Patent Application Publication
(10) Pub. No.: US 2026/0280621 A1
(43) Pub. Date: Sep. 17, 2026

(54) COMMUNICATION APPARATUS AND COMMUNICATION METHOD FOR UPLINK MULTI-LAYER TRANSMISSION

(71) Applicant: Panasonic Intellectual Property Corporation of America, Torrance, CA (US)

(72) Inventors: Yanyi DING, Singapore (SG); Yoshio URABE, Nara (JP); Hiroyuki MOTOZUKA, Kanagawa (JP)

(73) Assignee: Panasonic Intellectual Property Corporation of America, Torrance, CA (US)

(21) Appl. No.: 19/471,616

(22) PCT Filed: Mar. 27, 2024
(86) PCT No.: PCT/SG2024/050185

§ 371 Date: Oct. 1, 2025

(30) Foreign Application Priority Data
Apr. 6, 2023 (SG) 10202300953Q

(51) Int. Cl. H04B 7/0452; H04B 7/0404; H04L 5/00; H04W 72/1268

(52) U.S. Cl. CPC H04B 7/0452; H04B 7/0404; H04L 5/0023; H04L 5/0053; H04W 72/1268

(57) ABSTRACT

Communication apparatuses and methods for uplink multi-layer transmission are provided. One exemplary embodiment provides a first communication apparatus comprising: circuitry, which in operation, generates a signal for one or more second communication apparatuses, the signal indicating whether an uplink signal comprising two or more transmission layers is solicited or enabled; and a transmitter, which in operation, transmits the signal to the one or more second communication apparatuses.

### TECHNICAL FIELD

The present disclosure generally relates to communication methods and apparatuses, and more particularly relates to methods and apparatuses for uplink multi-layer transmission.

### BACKGROUND

In the standardization of next-generation WLAN, a new radio access technology necessarily having backward compatibility with Institute of Electrical and Electronics Engineers (IEEE) 802.11a/b/g/n/ac/ax/be technologies has been discussed in the Ultra High Reliability Study Group (UHR SG).

Multi-layer transmission is an efficient method to improve throughput as well as reliability at physical (PHY) layer. IEEE 802.11 ax/be does not define multi-layer transmission mode. IEEE 802.11n defines unequal modulation (UEQM), which applies different modulation mapping on symbols for different spatial streams. However, UEQM only supports single data stream transmission to a single user.

Broad ideas about multi-layer transmission were discussed in UHR, however, there has been no discussion on implementation of uplink multi-layer transmission.

There is thus a need for communication apparatuses and methods that can solve the above-mentioned issues. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for uplink multi-layer transmission.

According to an aspect of the present disclosure, there is provided a first communication apparatus comprising: circuitry, which in operation, generates a signal for one or more second communication apparatuses, the signal indicating whether an uplink signal comprising two or more transmission layers is solicited or enabled; and a transmitter, which in operation, transmits the signal to the one or more second communication apparatuses.

According to another aspect of the present disclosure, there is provided a second communication apparatus comprising: a receiver, which in operation, receives a signal from a first communication apparatus, the signal indicating whether an uplink signal comprising two or more transmission layers is solicited or enabled; and circuitry, which in operation, demodulates and decodes the signal to obtain two or more sets of transmit parameters for the uplink signal.

According to another aspect of the present disclosure, there is provided a communication method comprising: generating a signal for one or more communication apparatuses, the signal indicating whether an uplink signal comprising two or more transmission layers is solicited or enabled; and transmitting the signal to the one or more communication apparatuses.

According to another aspect of the present disclosure, there is provided a communication method comprising: receiving a signal, the signal indicating whether an uplink signal comprising two or more transmission layers is solicited or enabled; and demodulating and decoding the signal to obtain two or more sets of transmit parameters for the uplink signal.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts a Trigger-based Uplink Multi-user (TB UL MU) Transmission procedure in IEEE 802.11be specifications according to an example.

FIG. 2 depicts a trigger frame format with an extra high throughput (EHT) variant User Info field according to an example.

FIG. 3 depicts an EHT TB physical protocol data unit (PPDU) according to an example.

FIG. 4 depicts a buffer status report procedure according to various embodiments of the present disclosure.

FIG. 5 depicts a trigger frame format for soliciting a buffer status report according to various embodiments of the present disclosure.

FIG. 6 depicts an example Trigger-based Uplink Multi-user (TB UL MU) Multi-layer Transmission procedure in Ultra High Reliability (UHR).

FIG. 7 depicts an Ultra High Reliability (UHR) trigger frame format according to various embodiments of the present disclosure.

FIG. 8 depicts a trigger frame format including a plurality of User Info fields according to various embodiments of the present disclosure.

FIG. 9 depicts a plurality of User Info fields according to various embodiments of the present disclosure.

FIG. 10 depicts a User Info field with an End Flag subfield according to various embodiments of the present disclosure.

FIG. 11 depicts a flowchart for non-AP STA behavior when processing a trigger frame according to various embodiments of the present disclosure.

FIG. 12 depicts a flowchart for non-AP STA behavior when processing multiple User Info fields in a non-adaptive way according to various embodiments of the present disclosure.

FIG. 13 depicts a flowchart for non-AP STA behavior when processing multiple User Info fields in a self-adaptive way according to various embodiments of the present disclosure.

FIG. 14 depicts a trigger frame including Multi-layer User Info fields according to various embodiments of the present disclosure.

FIG. 15 depicts a Common Info field in a trigger frame including an indication for uplink multi-layer transmission according to various embodiments of the present disclosure.

FIG. 16 depicts a Multi-layer User Info field in a trigger frame including an indication for uplink multi-layer transmission according to various embodiments of the present disclosure.

FIG. 17 depicts a Multi-layer User Info field in a trigger frame including an indication for a size of the Multi-layer User Info field according to various embodiments of the present disclosure.

FIG. 18 depicts a flowchart for non-AP STA behavior when processing the trigger frame of any one of FIGS. 14-17 in a non-adaptive way according to various embodiments of the present disclosure.

FIG. 19 depicts a flowchart for non-AP STA behavior when processing the trigger frame of any one of FIGS. 14-17 in a self-adaptive way according to various embodiments of the present disclosure.

FIG. 20 depicts a trigger frame including both User Info fields and Multi-layer User Info fields of a same size according to various embodiments of the present disclosure.

FIG. 21 depicts an exemplary encoding of an UL UHR modulation coding scheme (UHR-MCS) subfield according to various embodiments of the present disclosure.

FIG. 22 depicts a trigger frame including both User Info fields and Multi-layer User Info fields of different sizes according to various embodiments of the present disclosure.

FIG. 23 depicts a flowchart for non-AP STA behavior when processing the trigger frame of FIG. 22 in a non-adaptive way according to various embodiments of the present disclosure.

FIG. 24 depicts a flowchart for non-AP STA behavior when processing the trigger frame format of FIG. 22 in a self-adaptive way according to various embodiments of the present disclosure.

FIG. 25 depicts a preamble for an UL transmission including an U-SIG field according to various embodiments of the present disclosure.

FIG. 26 depicts an UL Multi-layer Transmission Flag subfield included in an U-SIG field according to various embodiments of the present disclosure.

FIG. 27 depicts an UHR TB PPDU including an UL Multi-layer Transmission Parameter subfield according to various embodiments of the present disclosure.

FIG. 28 depicts a UHR TB PPDU including a new UHR-SIG field according to various embodiments of the present disclosure.

FIG. 29 shows a flow diagram illustrating a method for transmitting a signal for uplink multi-layer transmission according to various embodiments of the present disclosure.

FIG. 30 shows a flow diagram illustrating a method for receiving a signal for uplink multi-layer transmission according to various embodiments of the present disclosure.

FIG. 31 shows a schematic, partially sectioned view of a communication apparatus that can be implemented for uplink multi-layer transmission in accordance with various embodiments of the present disclosure.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. There is no intention to be bound by any theory presented in the preceding Background or this detailed description. Furthermore, other desirable features and characteristics will become apparent from the subsequent detailed description and the appended claims, taken in conjunction with the accompanying drawings and this background of the disclosure.

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for service discovery for local area network.

In the context of IEEE 802.11 (Wi-Fi) technologies, a station, which is interchangeably referred to as a STA, is a communication apparatus that has the capability to use the IEEE 802.11 protocol. Based on the IEEE 802.11-2020 definition, a STA can be any device that contains an IEEE 802.11-conformant media access control (MAC) and physical layer (PHY) interface to the wireless medium (WM).

For example, a station may be a laptop, a desktop personal computer (PC), a personal digital assistant (PDA), either an access point or not (e.g., either an AP STA or a non-AP STA), or a Wi-Fi phone in a wireless local area network (WLAN) environment. The station may be fixed or mobile. In the WLAN environment, the terms “STA”, “non-AP STA”, “client”, “wireless client”, “user”, “user device”, and “mobile terminal” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at different occasions, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

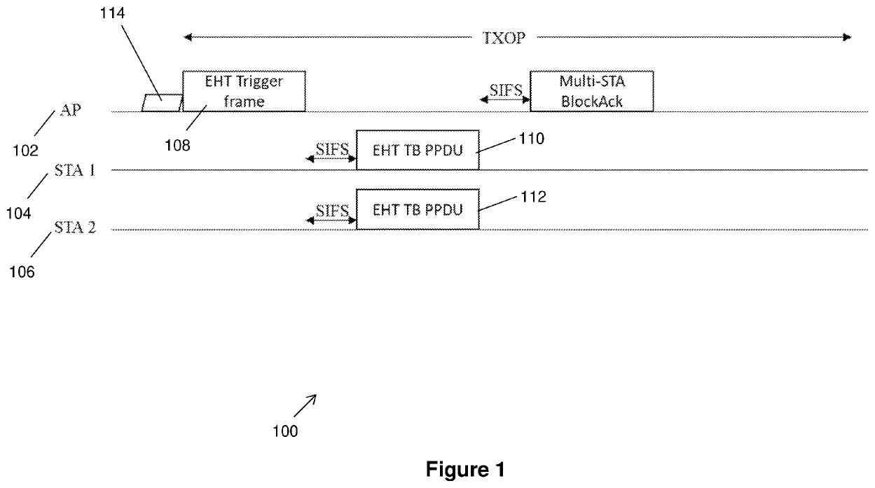

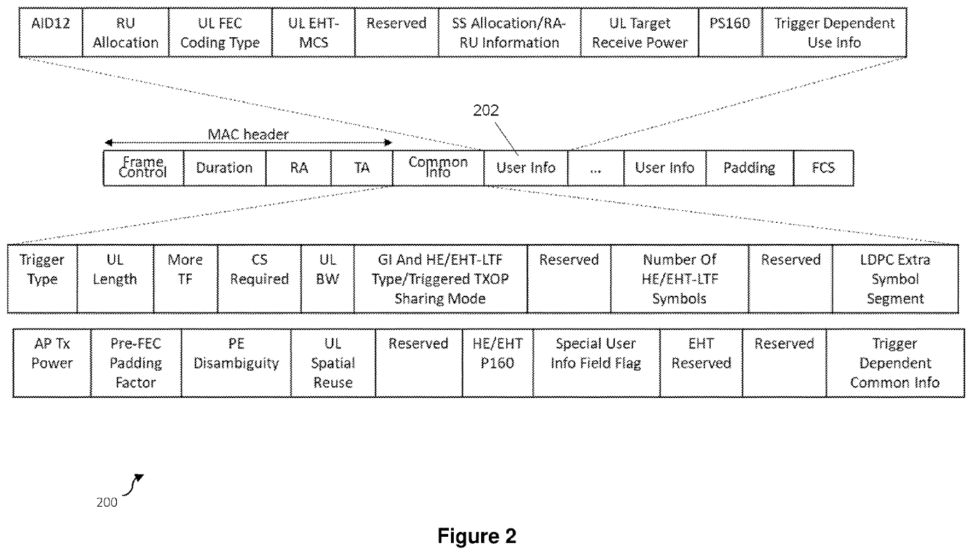

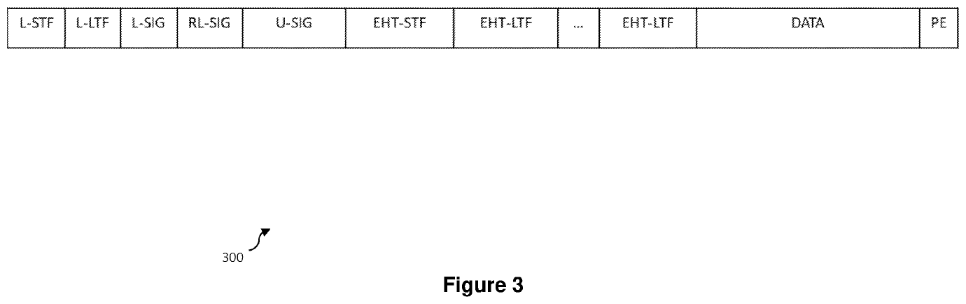

An example of a Trigger-based Uplink Multi-user (TB UL MU) Transmission procedure in IEEE 802.11be specifications is shown in illustration 100 of FIG. 1. For example, an AP 102 may transmit an extra high throughput (EHT) trigger frame 108 after a back off time 114 with transmit parameters for soliciting a EHT TB physical protocol data unit (PPDU) from non-AP STAs 104 and 106 (e.g., EHT TB PPDUs 110 and 112 from non-AP STAs 104 and 106 respectively). Each EHT TB PPDU 110 and 112 may be transmitted from non-AP STAs 104 and 106 on allocated resource unit (RU) and spatial stream(s) (SS(s)) following transmit parameters indicated in the EHT Trigger frame 108. A single physical layer service data unit (PSDU) may be transmitted by each of the non-AP STA 104 and 106. It will be appreciated by those skilled in the art that there may be specified short interframe space (SIFS) time intervals, for example as shown in FIG. 1 and other figures. An example of the EHT trigger frame 108 is shown in FIG. 2 in which trigger frame format 200 comprises an EHT variant of a User Info field 202. Further, FIG. 3 shows an example EHT TB PPDU format 300 which may be used for EHT TB PPDUs 110 and 112 as shown in FIG. 1.

A TB UL MU Multi-layer Transmission may be solicited by a Trigger frame containing information to indicate and solicit an UL multi-layer transmission from one or more non-AP STAs. The non-AP STA may transmit a UL multi-layer transmission in a TB PPDU. In the UL multi-layer transmission, one or more data streams (PSDUs) that are carried by different transmission layers which are protected by different transmit parameters are transmitted by a single non-AP STA in a TB PPDU.

In the present disclosure, several triggering options and variations are proposed for TB UL MU Multi-layer Transmission. In an option, the triggering may be performed in a non-adaptive way, such that whether or not to apply multi-layer transmission and all transmit parameters are decided by the AP who sends the trigger frame and are indicated in the trigger frame. The AP may advantageously decode and demodulate the UL multi-layer transmission without any additional signaling, and no change is needed for the TB PPDU. In another option, the triggering may be performed in a self-adaptive way, in which whether or not to apply multi-layer transmission is decided by the non-AP STA who receives the Trigger frame. All or partial transmit parameters are decided by the AP who sends the Trigger frame and are indicated in the Trigger frame. The non-AP STA may further decide partial transmit parameters by itself. A merit of this option is that UL multi-layer transmission may be transmitted only when necessary.

Further, the AP and non-AP STAs may indicate the capability of supporting UL multi-layer transmission prior to a UL multi-layer transmission. The capability may be indicated in an element (e.g., Multi-layer element, UHR Capabilities element) carried in a Beacon or a Probe Request/Response frame. The capability may also be indicated in a buffer status report carried in a TB Feedback null data packet/buffer status report (NDP/BSR). An AP may solicit a TB UL MU Multi-layer Transmission from a non-AP STA that indicates the capability of supporting UL multi-layer transmission. An AP shall not solicit a TB UL MU Multi-layer Transmission from a non-AP STA that does not indicate the capability of supporting UL multi-layer transmission.

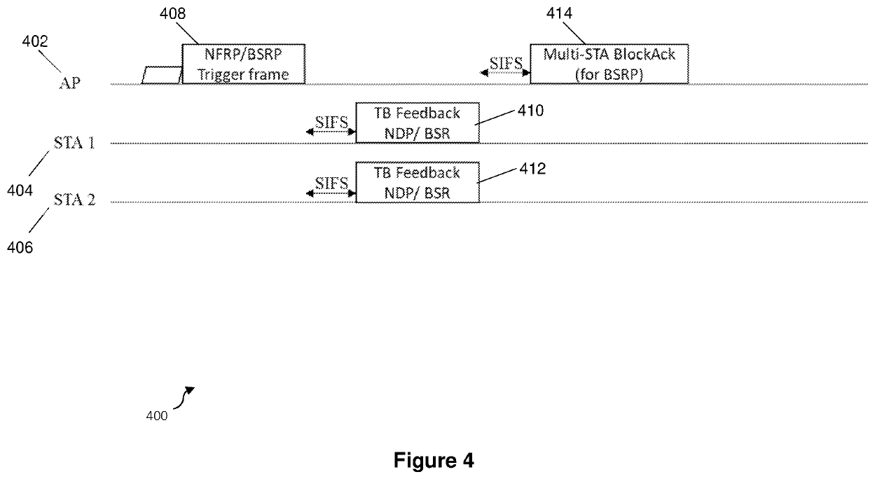

In an embodiment, prior to a TB UL MU Multi-layer Transmission, an AP may solicit Multi-layer buffer status report from non-AP STAs, to know the needs of non-AP STAs for a UL multi-layer transmission. For example, referring to illustration 400 of FIG. 4, an AP 402 may send a Null Data PPDU Feedback Report Poll (NFRP) or a Buffer Status Report Poll (BSRP) Trigger frame 408 to solicit a multi-layer buffer status report from non-AP STAs (e.g., in TB Feedback NDP or BSR 410 and 412 from non-AP STAs 404 and 406 respectively). The Multi-layer buffer status report may be contained in a TB Feedback NDP solicited by a NFRP trigger frame, or be contained in a Buffer Status Report (BSR) contained in a TB PPDU solicited by a BSRP trigger frame. In a case that TB PPDU containing a solicited BSR is transmitted from STA 404 and 406 to the AP 402 (e.g., in response to a BSRP Trigger frame transmitted from the AP 402), a multi-STA block acknowledgement frame 414 may be transmitted from the AP 402 to acknowledge the received TB PPDU.

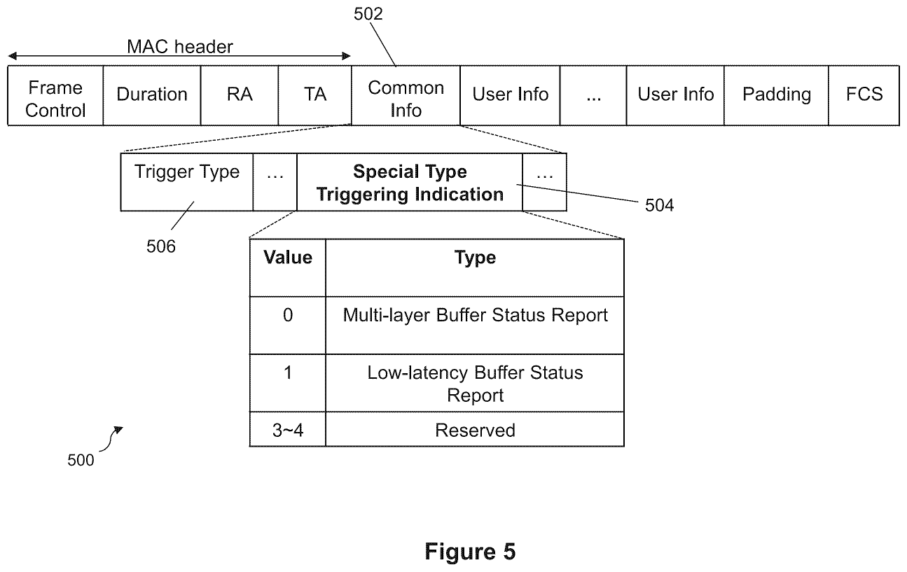

In the NFRP Trigger frame or BSRP Trigger frame, an indication for a special type of buffer status report (e.g., Multi-layer, low latency, etc.) being solicited may be included. For example, referring to Trigger frame 500 of FIG. 5, a Special Type Triggering Indication subfield 504 may be included in a Common Info field 502 of the trigger frame 500. The value of the Special Type Triggering Indication subfield may be 0, 1 or 3~4, in which the value ‘0’ may indicate a multi-layer BSR, the value ‘1’ may indicate a low-latency BSR, and value ‘3’ or ‘4’ may indicate reservation. It will be appreciated that such values may be changed to indicate different BSR types depending on application. Further, a Trigger Type subfield 506 of the Common Info field may be configured to indicate if the trigger type is BSRP or NFRP. If the special type of buffer status report is not solicited, non-AP STAs may only feedback the buffer status report in a same manner as specified in the IEEE 802.11be specifications.

Alternatively, the non-AP STA may also indicate the multi-layer buffer status in an unsolicited BSR, such like quality of service (QOS) Control field in QoS Null and QoS Data frames and in the BSR Control subfield (if present) in QoS Null, QoS Data, and Management frames. In the Multi-layer buffer status report, information may be included such as an uplink data buffer intended to be transmitted, priority level(s) of the uplink data, recommended transmit parameters for each priority levels of the uplink data, and other similar information.

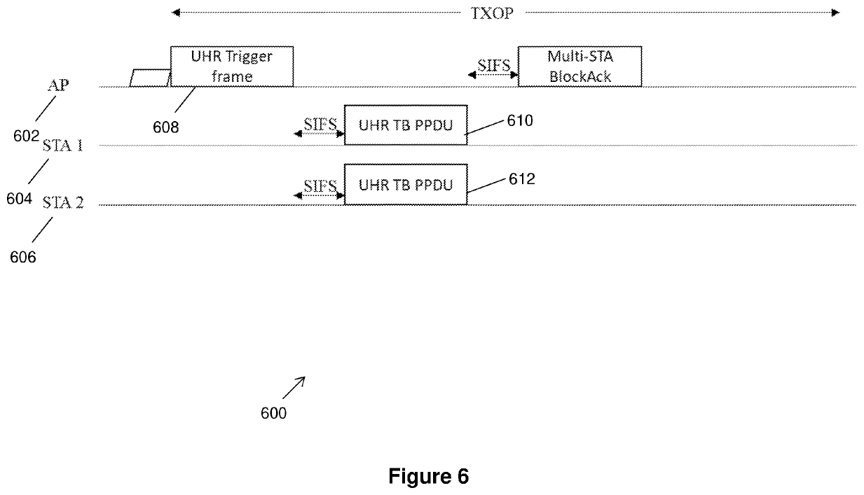

An example of a TB UL MU Multi-layer Transmission procedure is shown in illustration 600 of FIG. 6. For example, an AP 602 may transmit an UHR trigger frame 608 with transmit parameters for soliciting a UHR TB PPDU from non-AP STAs 604 and 606 (e.g., UHR TB PPDUs 610 and 612 from non-AP STAs 604 and 606 respectively). Each UHR TB PPDU 610 and 612 from non-AP STAs 604 and 606 may comprise an UL multi-layer transmission following transmit parameters indicated in the UHR Trigger frame 608. One or more PSDUs may be transmitted by each of the non-AP STA 604 and 606.

In a Trigger frame soliciting a TB UL MU Transmission, whether a UL multi-layer transmission (e.g., the UL multi-layer transmission may be referred to as an uplink signal comprising two or more transmission layers) from non-AP STA(s) is solicited or enabled may be indicated explicitly or implicitly. In an explicit indication, a subfield may be configured to indicate the information. In an implementation, to indicate the information in a non-adaptive way, an UL Multi-layer Tx subfield may be utilized to indicate whether a multi-layer transmission from non-AP STA(s) is solicited (e.g., the UL Multi-layer Tx subfield may be referred to as a first field indicating whether an uplink signal comprising two or more transmission layers is solicited). The UL Multi-layer Tx subfield may be either comprised in a User Info field, or in the Common Info field. If the UL Multi-layer Tx subfield is comprised in a User Info field, when the UL Multi-layer Tx subfield is set to 1, UL multi-layer transmission from the non-AP STA addressed by the User Info field may be solicited. If the UL Multi-layer Tx subfield is comprised in the Common Info field, when the UL Multi-layer Tx subfield is set to 1, UL multi-layer transmission from one or more non-AP STAs may be solicited. When the UL Multi-layer Tx subfield is set to 0, a normal UL transmission may be solicited. The normal UL transmission may be same as a UL transmission specified in the IEEE 802.11be specifications.

In IEEE802.11be, there is no signaling for an AP sending a Trigger frame to indicate an UL multi-layer transmission, and there is no processing rule for a non-AP STA receiving the Trigger frame to understand that an UL multi-layer transmission is being solicited. With an explicit or an implicit indication, an UL multi-layer transmission can advantageously be solicited or enabled. The explicit indication requires a small change on the AP side (e.g., adding a new signaling in the Trigger frame) while enabling almost the same processing procedure of a Trigger frame (e.g., as in IEEE802.11be) on the non-AP side. The implicit indication requires change on both AP and non-AP STA sides but has less impact on devices of previous amendments of the IEEE802.11 specifications, thus enabling backward compatibility.

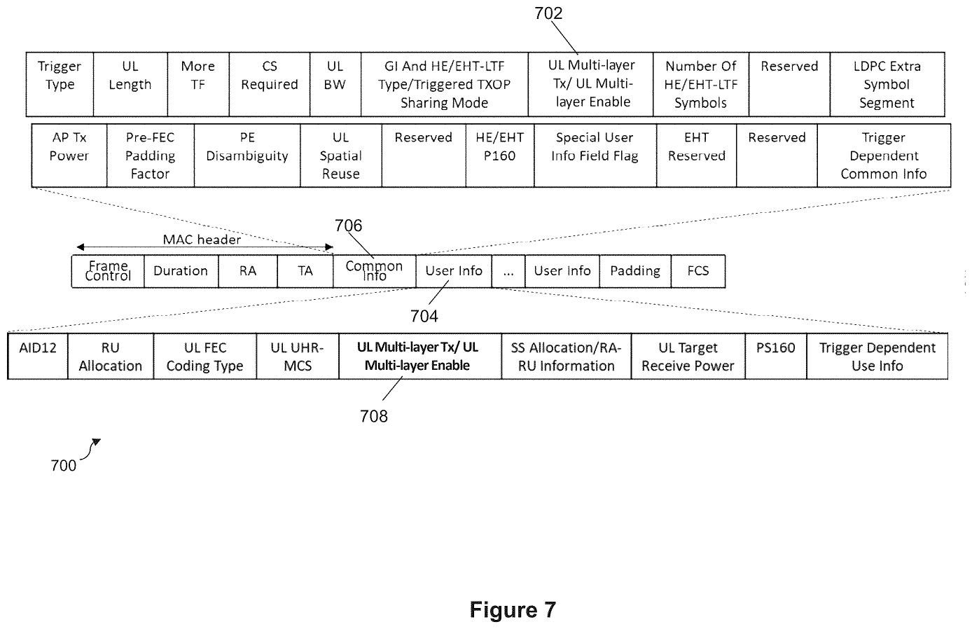

In an implementation, to indicate the information in a self-adaptive way, an UL Multi-layer Enable subfield may be utilized to indicate whether a multi-layer transmission from non-AP STA(s) is enabled (e.g., the UL Multi-layer Enable subfield may be referred to as a first field indicating whether an uplink signal comprising two or more transmission layers is enabled). The UL Multi-layer Enable subfield may be either comprised in a User Info field, or in the Common Info field. If the UL Multi-layer Enable subfield is comprised in a User Info field, when the UL Multi-layer Tx subfield is set to 1, UL multi-layer transmission from the non-AP STA addressed by the User Info field may be enabled. If the UL Multi-layer Enable subfield is comprised in the Common Info field, when the UL Multi-layer Enable subfield is set to 1, UL multi-layer transmission from one or more non-AP STAs may be enabled. This implementation may not be applicable to a UL MU-MIMO transmission. The non-AP STA for which UL multi-layer transmission is indicated as enabled, may decide whether to transmit a UL multi-layer transmission based on link and buffer status. Further, when the UL Multi-layer Enable subfield is set to 0, UL multi-layer transmission may be disabled. The non-AP STA for which UL multi-layer transmission is indicated as disabled, shall not transmit a multi-layer transmission in the TB PPDU. FIG. 7 depicts an UHR trigger frame format 700 including a UL Multi-layer Tx/Enable subfield 702 or 708 as described above for explicit indication of whether a UL multi-layer transmission from non-AP STA(s) is solicited or enabled. As explained above, the subfield 702 may be included in a Common Info field 706; the subfield 708 may be included in a User Info field 704.

Further, for an implicit indication of whether a UL multi-layer transmission from non-AP STA(s) is solicited or enabled, no specific subfield may be needed to indicate the information. Instead, the information is indicated by the presence of specific User Info fields or a total number of sets of transmit parameters allocated to the non-AP STA.

In an embodiment, in a Trigger frame soliciting a TB UL MU Transmission, when a UL multi-layer transmission is solicited or enabled (e.g., either in a non-adaptive way or in a self-adaptive way), transmit parameters may be further indicated in the Trigger frame. In a first option, the transmit parameters may be indicated in multiple User Info fields (e.g., the multiple User Info fields may be referred to as two or more second fields indicating two or more sets of transmit parameters which correspond to two or more transmission layers of the uplink signal respectively). For example, transmit parameters for the multi-layer transmission may be indicated by a plurality of User Info fields specified with a same association identifier (AID) (e.g., the multiple User Info fields may be referred to as two or more second fields that are addressed by a same identifier, and the two or more second fields may comprise two or more third fields indicating two or more sets of transmit parameters for the two or more transmission layers of the uplink signal respectively). Allocated RU for each transmission layer is indicated in the RU Allocation subfield along with the position of each User Info field corresponding to the transmission layer. For example, each of the two or more second fields may comprise a fourth field (RU Allocation subfield) indicating a resource unit (RU) allocation information for the two or more sets of transmission layers of the uplink signal. The AP may allocate each RU based on transmit parameters of each transmission layer or other parameters such as size or rate of the content in the layer. Using this option, there is advantageously no impact on legacy non-AP STAs to decode the trigger frame, although a long trigger frame may be needed. In a second option, the transmit parameters may be indicated in a Multi-layer User Info field. Transmit parameters for the multi-layer transmission may be indicated by a Multi-layer User Info field specified with the corresponding AID. For example, the Multi-layer User Info field may be referred to as a second field indicating two or more sets of transmit parameters corresponding to the two or more transmission layers of the uplink signal. The two or more sets of transmit parameters may be indicated in two or more third fields in the second field, and RU allocation information may be indicated in a fourth field in the second field. With this option, legacy non-AP STAs may be impacted, but a shorter trigger frame (compared to the first option) can be used.

The transmit parameters may be indicated in multiple User Info fields. Whether an UL multi-layer transmission from non-AP STA(s) is solicited or enabled may be indicated implicitly based on whether more than one User Info field (and thus having more than one sets of transmit parameters) is assigned to a single non-AP STA (e.g., the indication whether the uplink signal is solicited or enabled may be based on a presence of two or more second fields, or based on a total number of sets of transmit parameters). For example, if multiple User Info fields are assigned to a single non-AP STA, an UL multi-layer transmission may be solicited or enabled from the non-AP STA. If only one User Info field is assigned to a single non-AP STA, a normal UL transmission may be solicited from the non-AP STA. When more than one User Info field is assigned to a single non-AP STA, in a non-adaptive way, each single User Info field assigned to the same non-AP STA may carry a single set of transmit parameters for each one of transmission layers in the UL multi-layer transmission of the non-AP STA. In a self-adaptive way, one of a plurality of User Info fields assigned to a non-AP STA may carry a set of transmit parameters for a normal UL transmission (e.g., same UL transmission as in IEEE 802.11be) if the non-AP STA determines not to transmit a UL multi-layer transmission, while each of the remaining User Info fields may carry a single set of transmit parameters for each one of transmission layers if the non-AP STA determines to transmit a UL multi-layer transmission.

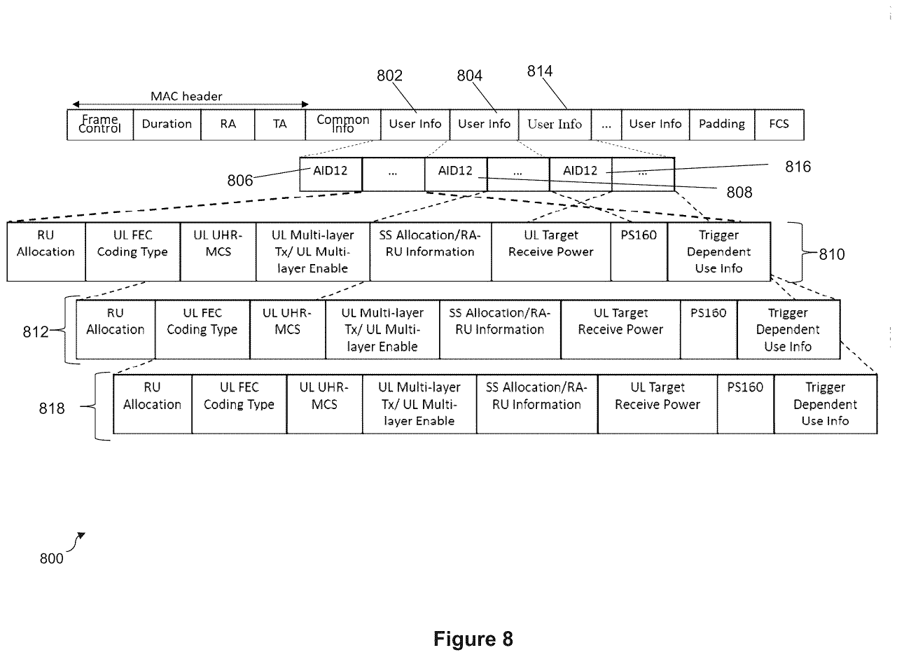

FIG. 8 depicts a trigger frame 800 including a plurality of User Info fields (for example, User Info fields 802, 804 and 814 in FIG. 8) according to various embodiments of the present disclosure. A value indicated in an AID12 subfield 806 in User Info field 802 and a value indicated in an AID12 subfield 808 in another User Info field 804 of the trigger frame 800 may be the same, for example to indicate that transmit parameters for UL multi-layer transmission are provided in the User Info field 802 (e.g., transmit parameters 810) and the User Info field 804 (e.g., transmit parameters 812). Thus, the two or more second fields (e.g., User Info fields 802 and 804) may comprise two or more third fields indicating the two or more sets of transmit parameters (e.g., the fields indicating the transmit parameters 810 in User Info field 802 and transmit parameters 812 in User Info field 804) for the two or more transmission layers of the uplink signal respectively. In an implementation, in non-adaptive way, the transmit parameters 810 included in the User Info field 802 may be assigned to a first transmission layer of the solicited UL multi-layer transmission to a non-AP STA, while the transmit parameters 812 included in the User Info field 804 may be assigned to a second transmission layer of the solicited UL multi-layer transmission to the non-AP STA. In another implementation, in a self-adaptive way, the trigger frame 800 may further include a User Info field 814 comprising an AID12 subfield 816 with same value as AID12 subfield 806 and 808. In this example, the transmit parameters 810 included in the User Info field 802 may be assigned to a normal UL transmission (e.g., same UL transmission as in IEEE 802.11be instead of UL multi-layer transmission) if the non-AP STA determines not to transmit a UL multi-layer transmission. The transmit parameters included in the User Info field 804 may be assigned to a first transmission layer to the non-AP STA, while the transmit parameters 818 included in the User Info field 814 may be assigned to a second transmission layer to the non-AP STA, if the non-AP STA determines to transmit a UL multi-layer transmission.

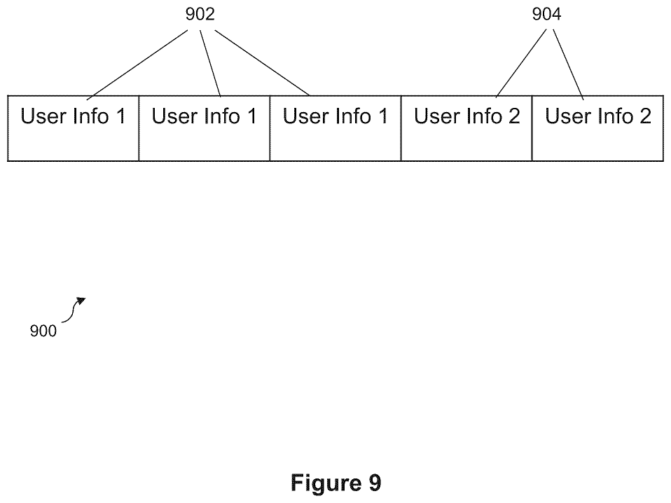

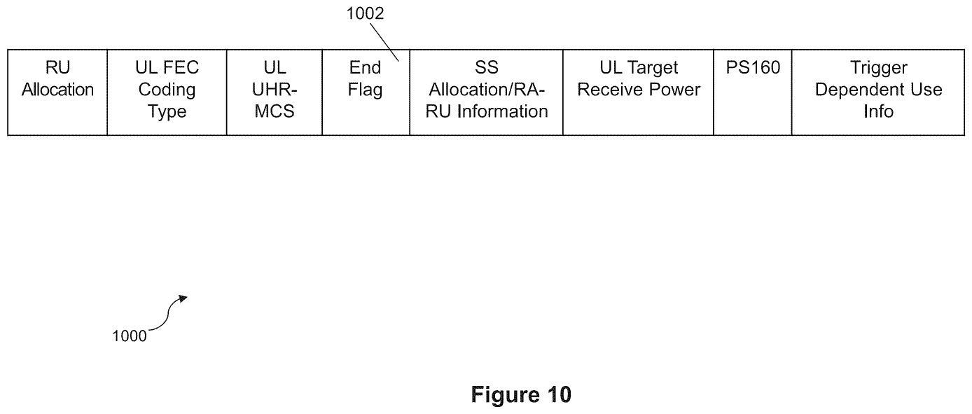

Since there may be multiple User Info fields assigned to a single non-AP STA, an end of the multiple User Info fields may be indicated. In an implementation, multiple User Info fields for the same non-AP STA shall be consecutively arranged in a Trigger frame and the end of the multiple User Info fields may be implicitly indicated based on a different User Info field (e.g., having an AID value that is different from previous User Info fields) after the last one of the multiple User Info fields. The non-AP STA may stop checking for further User Info fields once it finds a first User Info field addressed with a different AID after encountering multiple continuous user Info fields that are assigned to it. For example, referring to multiple user info fields 900 as shown in FIG. 9, each User Info 1 field 902 is intended for a first non-AP STA and includes an AID12 subfield set to the same AID value which is assigned to the first non-AP STA, and each User Info 2 field 904 is intended for a second non-AP STA includes an AID12 subfield set to an AID12 subfield set to the same AID value which is assigned to the second non-AP STA. In the example, the AID value indicated in the User Info 1 field is different from the AID value indicated in the User Info 2 field. A difference in AID value of a last User Info 1 field 902 and a first User Info 2 field 904 indicates the end of User Info fields associated with User Info 1 in which User Info 1 includes an AID value indicating the intended non-AP STA and User Info 2 includes a different AID value. In another implementation, the end of the multiple User Info fields may be explicitly indicated by a subfield (e.g., End Flag subfield 1002 in User Info field 1000 of FIG. 10) comprised in the last User Info field of the multiple User Info fields assigned to a single non-AP STA. The explicit indication of the end of the multiple User Info fields (e.g., End Flag subfield) may also be used when the UL multi-layer transmission is explicitly indicated by the UL Multi-layer Tx/UL Multi-layer Enable subfield. When the UL Multi-layer Tx/UL Multi-layer Enable subfield is comprised in User Info fields, the UL Multi-layer Tx/UL Multi-layer Enable subfield may be used for the indication instead of the End Flag subfield by setting its value to 0 in the last User Info field while the values are set to 1 in other User Info fields in the multiple User Info field. The non-AP STA may stop checking for further User Info fields once it finds an indication of the end of the multiple User Info fields (e.g., an End Flag subfield which is set to 1) comprised in an assigned User Info field.

In an implementation, when a non-AP STA receives a trigger frame comprising multiple User Info fields, it may proceed to process the multiple User Info fields based on specified processing steps if the non-AP STA satisfies any one of the following conditions: (1) the non-AP STA is addressed by a User Info field comprising a UL Multi-layer Tx/UL Multi-layer Enable subfield set to 1; (2) the non-AP STA supports UL multi-layer transmission, and the Common Info field of the trigger frame comprises a UL Multi-layer Tx/UL Multi-layer Enable subfield set to 1, and the non-AP STA is addressed by multiple User Info fields; and (3) the non-AP STA is addressed by multiple User Info fields. The processing steps for processing the multiple User Info fields may be as follows: (1) the non-AP STA checks the trigger frame to find all User Info fields specified with a corresponding AID; (2) in a non-adaptive way, the non-AP STA prepares the UL multi-layer transmission according to the multiple sets of transmit parameters indicated in the multiple User Info fields, and in a self-adaptive way, the non-AP STA determines whether to transmit the UL multi-layer transmission; (3) the non-AP STA then prepares the UL transmission according to the User Info field carrying transmit parameters for a normal UL transmission if it determines not to transmit a UL multi-layer transmission. Otherwise, the non-AP STA prepares the UL multi-layer transmission according to the multiple sets of transmit parameters indicated in the multiple User Info fields.

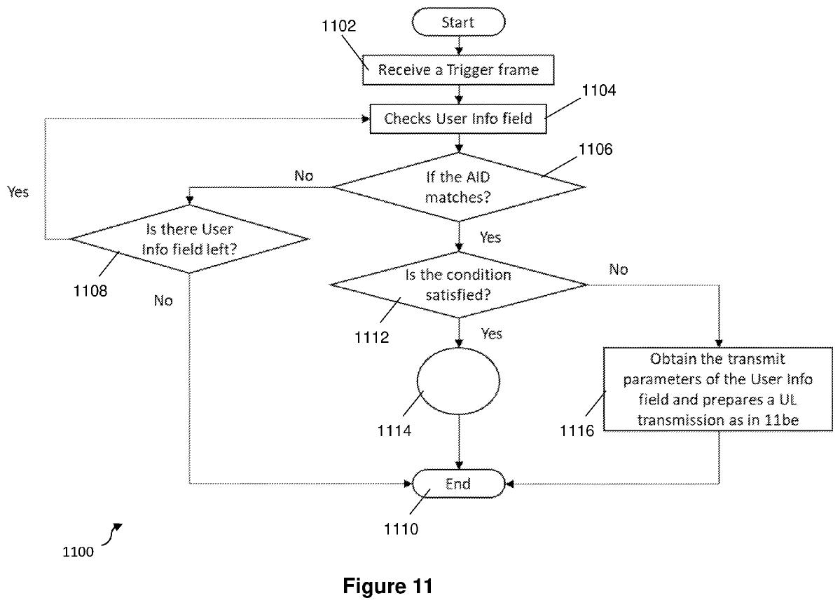

FIG. 11 depicts a flowchart 1100 for non-AP STA behavior when processing a trigger frame according to various embodiments of the present disclosure. At step 1102, a trigger frame is received by the non-AP STA. At step 1104, the non-AP STA checks a User Info field of the trigger frame. Next, at step 1106, the non-AP STA determines if an AID value of the User Info field (e.g., indicated in an AID12 field of the User Info field) matches with an AID value associated with the non-AP STA. If it is determined that the AID does not match, the process proceeds to step 1108. At step 1108, the non-AP STA determines if there are any unchecked User Info fields. If it is determined that there are User Info fields remaining unchecked, the process returns from step 1108 to step 1104 to check the User Info field, e.g., the first unchecked User Info field determined at step 1108. If the non-AP STA determines, at step 1108, that no User Info field is left for checking (or in other words, all User Info fields have been checked), the process may then end at step 1110.

On the other hand, if it is determined at step 1106 that the AID matches (e.g., the AID value of the User Info field and the AID value associated with the non-AP STA are same), the process proceeds to step 1112 in which it is determined whether a condition is satisfied. The condition may be any one of the following: (1) the non-AP STA is addressed by a User Info field comprising a UL Multi-layer Tx/UL Multi-layer Enable subfield set to 1; (2) the non-AP STA supports UL multi-layer transmission, and the Common Info field of the received trigger frame comprises a UL Multi-layer Tx/UL Multi-layer Enable subfield set to 1, and the non-AP STA is addressed by multiple User Info fields; (3) the non-AP STA is addressed by multiple User Info fields.

If it is determined that any one of these conditions is satisfied, then the process proceeds to step 1114 in which a plurality of User Info fields whose AID value matches are processed by the non-AP STA as follows: (1) the non-AP STA checks the trigger frame to find all User Info fields specified with a corresponding AID; (2) in a non-adaptive way, the non-AP STA prepares the UL multi-layer transmission according to the multiple sets of transmit parameters indicated in the multiple User Info fields, and in a self-adaptive way, the non-AP STA determines whether to transmit the UL multi-layer transmission; and (3) the non-AP STA then prepares the UL transmission according to the User Info field carrying transmit parameters for a normal UL transmission if it determines not to transmit a UL multi-layer transmission. Otherwise, the non-AP STA prepares the UL multi-layer transmission according to the multiple sets of transmit parameters indicated in the multiple User Info fields. After step 1114, the process may end at step 1110.

If it is determined at step 1112 that none of the conditions are satisfied, the process proceeds to step 1116 in which the non-AP STA obtains the transmit parameters of the checked User Info field and prepares an UL transmission in accordance with the IEEE 802.11be specifications. After step 1116, the process may end at step 1110.

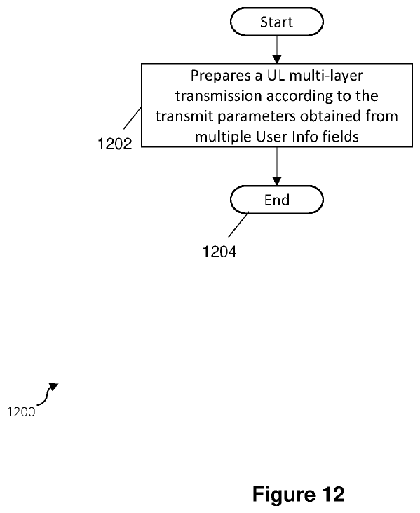

FIG. 12 depicts a flowchart 1200 for non-AP STA behavior when processing multiple User Info fields in a non-adaptive way (e.g., in step 1114 of flowchart 1100) according to various embodiments of the present disclosure. At step 1202, a non-AP STA may prepare an UL multi-layer transmission according to the transmit parameters obtained from multiple User Info fields, and the process ends at step 1204.

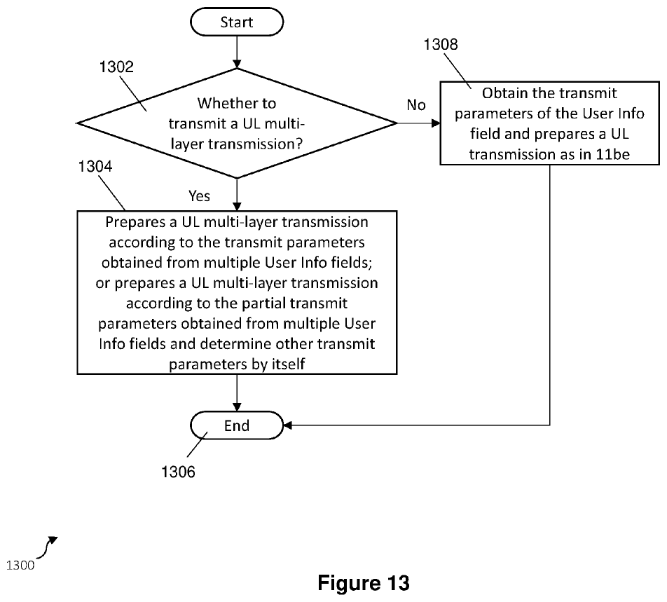

Further, FIG. 13 depicts a flowchart 1300 for non-AP STA behavior when processing multiple User Info fields in a self-adaptive way (e.g., in step 1114 of flowchart 1100) according to various embodiments of the present disclosure. At step 1302, the non-AP STA determines whether to transmit a UL multi-layer transmission. If it is determined that a UL multi-layer transmission is to be transmitted, the process proceeds to step 1304 in which the non-AP STA prepares a UL multi-layer transmission according to the transmit parameters obtained from multiple User Info fields, or prepares a UL multi-layer transmission according to partial transmit parameters obtained from the multiple User Info fields and then determine other transmit parameters by itself. The process then ends at step 1306. If it is determined at step 1302 that the non-AP STA will not transmit an UL multi-layer transmission, the process proceeds to step 1308 in which the non-AP STA obtains the transmit parameters of the User Info field and prepares an UL transmission in accordance with the IEEE 802.11be specifications, and the process may end at step 1306.

Transmit parameters for UL multi-layer transmission may be indicated in a Multi-layer User Info field. Whether an UL multi-layer transmission from non-AP STA(s) is solicited or enabled may be indicated implicitly by whether a Multi-layer User Info field (e.g., indicating two or more sets of transmit parameters instead of only one set) is assigned to the non-AP STA (e.g., the indication whether the uplink signal is solicited or enabled may be based on a presence of the Multi-layer User Info field, or based on a total number of sets of transmit parameters). If a Multi-layer User Info field is assigned to a non-AP STA, an UL multi-layer transmission is solicited or enabled from the non-AP STA. If a User Info field is assigned to a non-AP STA, it is implied that a normal UL transmission is solicited from the non-AP STA. In an implementation, only Multi-layer User Info fields, Padding field and Frame Check Sequence (FCS) field are included after the Common Info field in a Trigger frame. For simplicity, the trigger frame is referred to a Trigger frame only comprising Multi-layer User Info fields in following texts. A Trigger frame only comprising Multi-layer User Info fields may be specified either by a subfield of a Common Info field or a subfield of each Multi-layer User Info field in the trigger frame. This advantageously makes processing of the trigger frame less complex and there is no impact on legacy non-AP STAs. In another implementation, Multi-layer User Info fields, User Info fields, Padding field and Frame Check Sequence (FCS) field may be included after the Common Info field in the trigger frame. A Multi-layer User Info field may be differentiated from a User Info field by a subfield comprised in the Multi-layer User Info field. A Multi-layer User Info field may be of a same size as or a different size from a User Info field. This implementation advantageously enables more flexibility, as it is possible for a trigger frame to solicit UL multi-layer and normal transmission simultaneously.

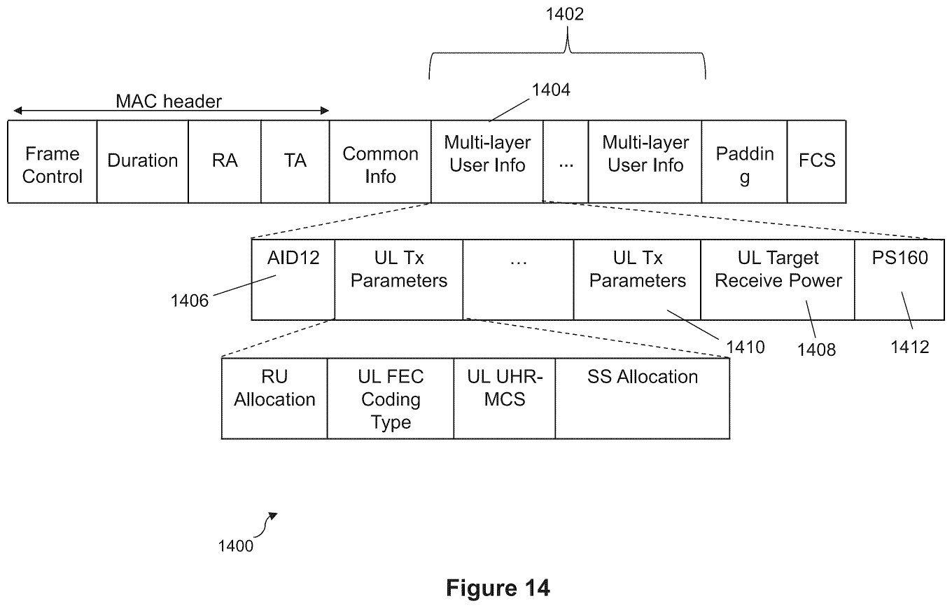

FIG. 14 depicts a trigger frame 1400 which includes only Multi-layer User Info fields 1402 according to various embodiments of the present disclosure. Since all User Info fields 1402 in the trigger frame 1400 are Multi-layer User Info fields, these fields as a whole may be referred to as “only Multi-layer User Info fields” 1402. A multi-layer User Info field 1404 may comprise an AID12 subfield 1406, UL Target Receive Power subfield 1408, PS160 subfield 1412 and multiple UL Tx Parameters subfields 1410. For example, the second field (e.g., Multi-layer User Info field 1404) may comprise two or more third fields (e.g., UL Tx Parameters subfields 1410) indicating the two or more sets of transmit parameters for the two or more transmission layers of the uplink signal respectively. The Multi-layer User Info field 1404 is addressed to an associated non-AP STA whose AID is equal to the value in the AID12 subfield 1406. In a non-adaptive way of processing the trigger frame 1400, in each UL Tx Parameters subfield 1410, a set of transmit parameters for a single transmission layer may be indicated, such that different UL Tx Parameters subfields may carry different sets of transmit parameters. In a self-adaptive way of processing the trigger frame 1400, in one of the UL Tx Parameters subfields 1410, transmit parameters for a normal transmission if the non-AP STA determines not to transmit a UL multi-layer transmission may be indicated, while in other UL Tx Parameters subfields, transmit parameters for each single transmission layer may be indicated.

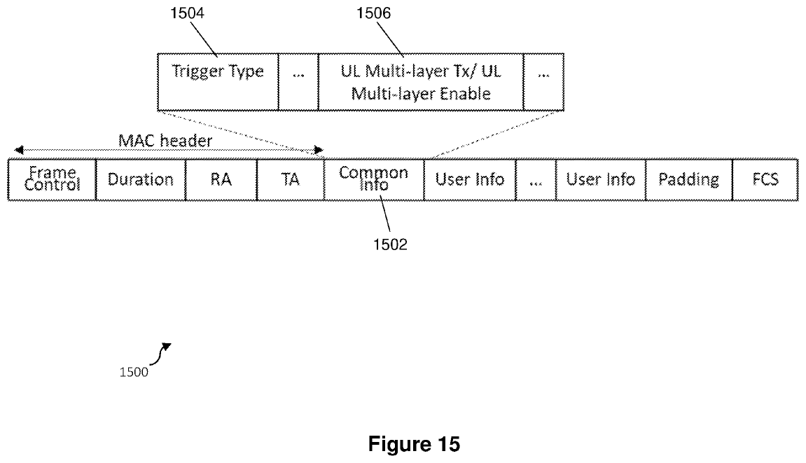

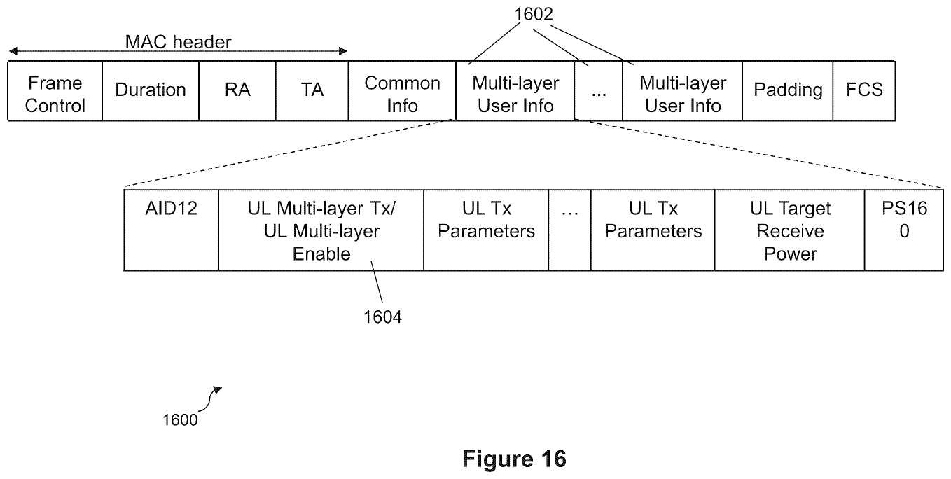

FIG. 15 depicts a Common Info field 1502 in a trigger frame 1500 according to various embodiments of the present disclosure. The Common Info field 1502 may include an indication for uplink multi-layer transmission. For example, ‘only Multi-layer User Info fields are included in the trigger frame’ may be indicated by a Trigger Type subfield 1504 and/or a UL Multi-layer Tx/UL Multi-layer Enable subfield 1506 of the Common Info field 1502. Further referring to trigger frame 1600 of FIG. 16, only Multi-layer User Info fields are included in the trigger frame’ may also be indicated by a UL Multi-layer Tx/UL Multi-layer Enable subfield 1604 in each of a plurality of Multi-layer User Info fields 1602 in the trigger frame 1600, such that the value of the UL Multi-layer Tx/UL Multi-layer Enable subfield in each of the plurality of Multi-layer User Info fields 1602 may be the same.

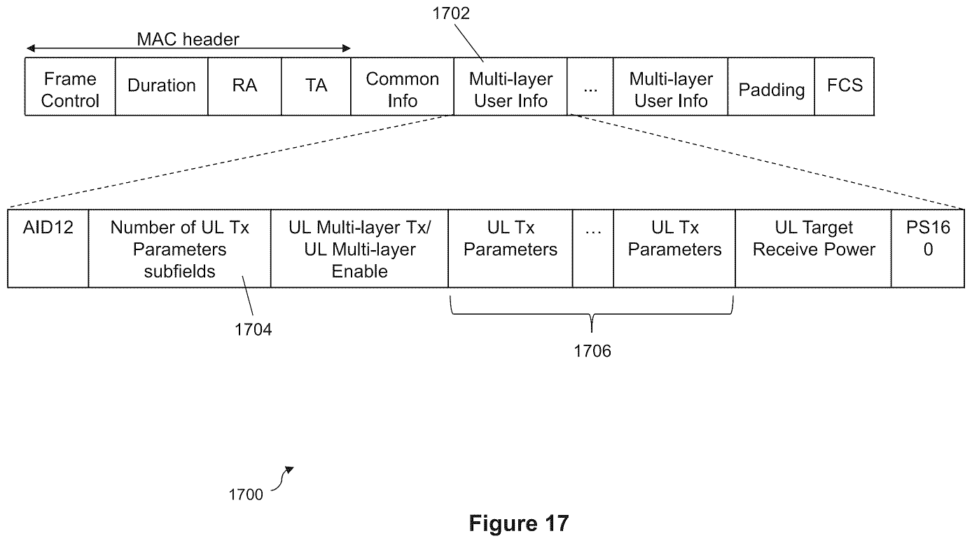

The size of each Multi-layer User Info field may be flexible, and the size of a Multi-layer User Info field may be indicated in a subfield of the Multi-layer User Info field. FIG. 17 depicts a Multi-layer User Info field 1702 in a trigger frame 1700 according to various embodiments of the present disclosure. The Multi-layer User Info field 1702 may indicate its size. The size of Multi-layer User Info field 1702 may be indicated by N (e.g., the value of Number of UL Tx Parameters subfield 1704, where N is an integer and N≥2) which is the number of UL Tx Parameters subfields 1706 comprised in corresponding Multi-layer User Info field 1702. The Number of UL Tx Parameters subfield may be referred to herein as a sixth field for indicating a size of the second field (e.g., the Multi-layer User Info field).

When a non-AP STA receives a trigger frame containing one or more Multi-layer User Info fields and without any User Info field, the non-AP STA may be configured to take the following steps: the non-AP STA stops decoding the trigger frame if it does not support UL multi-layer transmission, or proceeds to a next step if it supports UL multi-layer transmission; in the next step, the non-AP STA checks Multi-User Info fields of the trigger frame until it identifies the Multi-layer User Info field specified with an AID that corresponds to an AID associated with the non-AP STA. In a non-adaptive way of processing the Multi-layer User Info field with the corresponding AID, the non-AP STA prepares the UL multi-layer transmission according to the multiple sets of transmit parameters indicated in the Multi-layer User Info field. In a self-adaptive way of processing the Multi-layer User Info field with the corresponding AID, the non-AP STA determines whether to transmit the UL multi-layer transmission. The non-AP STA prepares the UL transmission according to the Multi-layer User Info field if it determines not to transmit a UL multi-layer transmission. Otherwise, the non-AP STA prepares the UL multi-layer transmission according to the multiple sets of transmit parameters indicated in the Multi-layer User Info field.

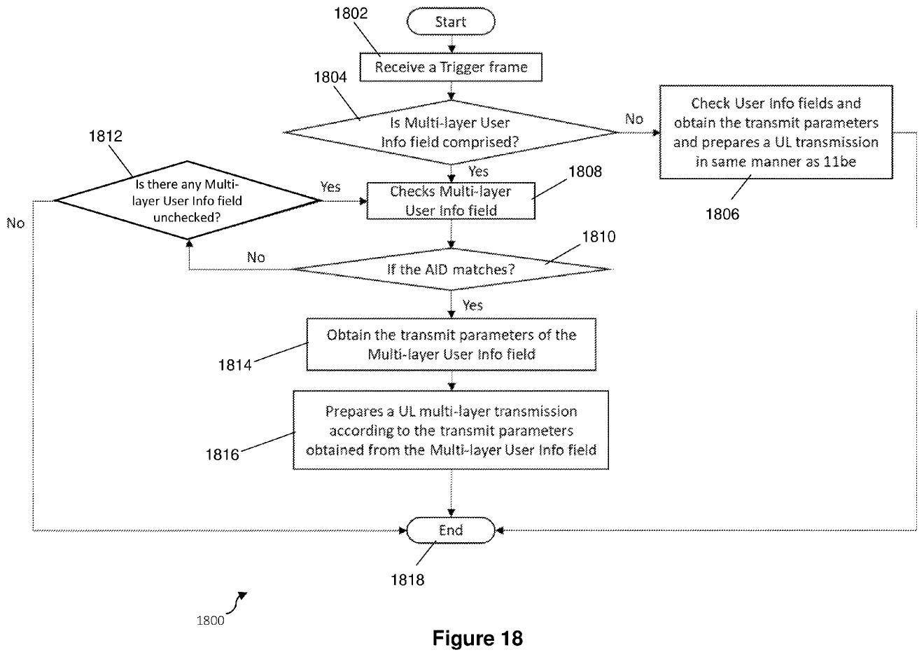

FIG. 18 depicts a flowchart 1800 for non-AP STA behavior when processing a trigger frame in a non-adaptive way according to various embodiments of the present disclosure. The trigger frame may be any one as shown in FIGS. 14 to 17. At step 1802, a non-AP STA receives a trigger frame. At step 1804, it is checked whether the trigger frame comprises any Multi-layer User Info field(s). If the trigger frame does not comprise any Multi-layer User Info field, the process proceeds to step 1806. At step 1806, the non-AP STA checks User Info fields comprised in the trigger frame, obtains the transmit parameters and prepares an UL transmission in a same manner as specified in the IEEE 802.11be specifications. After step 1806, the process may end at step 1818. On the other hand, if it is determined at step 1804 that there exists one or more Multi-layer User Info fields, the process proceeds to step 1808. At step 1808, the non-AP STA checks one of the Multi-layer User Info field(s) and then proceeds to step 1810. At step 1810, the non-AP STA determines if an AID indicated in the Multi-layer User Info field matches with the AID associated with the non-AP STA. If the AID does not match with the AID associated with the non-AP STA, the process may proceed to step 1812. At step 1812, the non-AP STA determines if there are any unchecked Multi-layer User Info fields in the trigger frame. If there are unchecked Multi-layer User Info fields (left) in the trigger frame, the process returns from step 1812 to step 1808 to check the first unchecked Multi-layer User Info field determined in step 1812. If it is determined at step 1812 that no Multi-layer User Info field(left) in the trigger frame has not been checked (or in other words, all Multi-layer User Info fields in the trigger frame have been checked), then the process may proceed to and end at step 1818.

On the other hand, if it is determined at step 1810 that the AID value matches, then the process may proceed to step 1814 where transmit parameters of the Multi-layer User Info field are obtained. Next, at step 1816, the non-AP STA prepares an UL multi-layer transmission according to the transmit parameters obtained from the Multi-layer User Info field at step 1814, and then the process ends at step 1818.

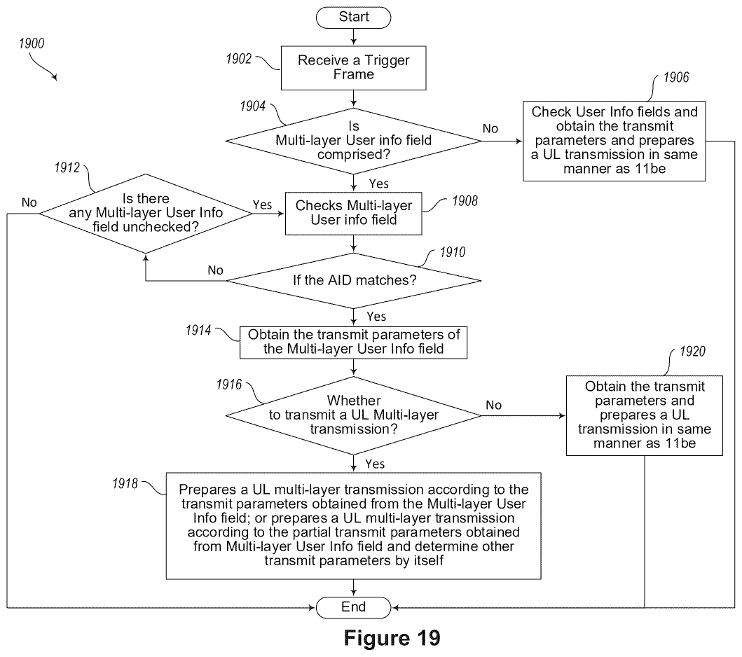

FIG. 19 depicts a flowchart 1900 for non-AP STA behavior when processing a trigger frame in a self-adaptive way according to various embodiments of the present disclosure. The trigger frame may be any one as shown in FIGS. 14 to 17. At step 1902, a non-AP STA receives a trigger frame. At step 1904, it is checked whether the trigger frame comprises any Multi-layer User Info field(s). If the trigger frame does not comprise any Multi-layer User Info field, the process proceeds to step 1906 in which the non-AP STA checks User Info fields comprised in the trigger frame, obtains the transmit parameters and prepares an UL transmission in a same manner as specified in the IEEE 802.11be specifications. The process then ends at step 1922. On the other hand, if it is determined at step 1904 that there exists one or more Multi-layer User Info fields, the process proceeds to step 1908 in which the non-AP STA checks one of the Multi-layer User Info field(s). At step 1910, it is determined whether an AID indicated in the Multi-layer User Info field matches with an AID associated with the non-AP STA. If it is determined that the AID does not match, the process proceeds to step 1912 in which it is determined whether there are any Multi-layer User Info fields left in the trigger frame that are not checked. If there are, the process returns to step 1908 to check a next Multi-layer User Info field. Otherwise, the process ends at step 1922. On the other hand, if it is determined at step 1910 that the AID value matches, the process proceeds to step 1914 in which transmit parameters of the Multi-layer User Info field is obtained. At step 1916, the non-AP STA determines whether an UL Multi-layer transmission should be transmitted (e.g., a self-adaptive procedure). If it is determined that an UL Multi-layer transmission should not be transmitted, the non-AP STA obtains the transmit parameters and prepares an UL transmission in a same manner as specified in the IEEE 802.11be specifications, and the process ends at step 1922. Otherwise, the process proceeds from step 1916 to step 1918, in which the non-AP STA prepares an UL multi-layer transmission according to the transmit parameters obtained from the Multi-layer User Info field, or prepares an UL multi-layer transmission according to the partial transmit parameters obtained from Multi-layer User Info field and according to other transmit parameters that are determined by itself, and the process ends at step 1922.

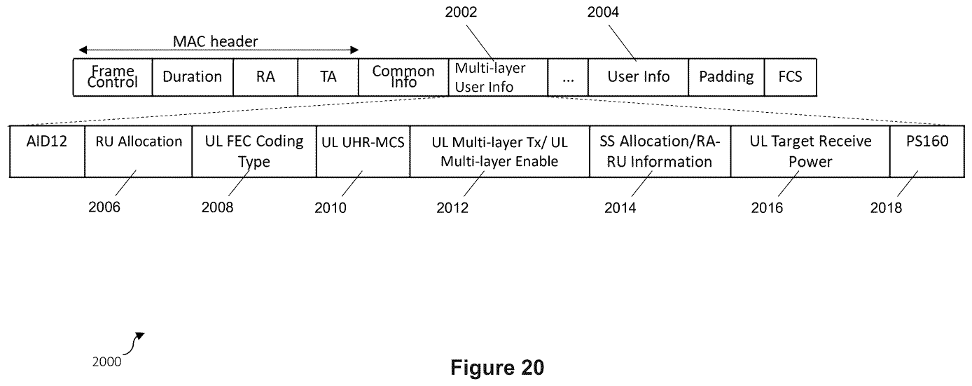

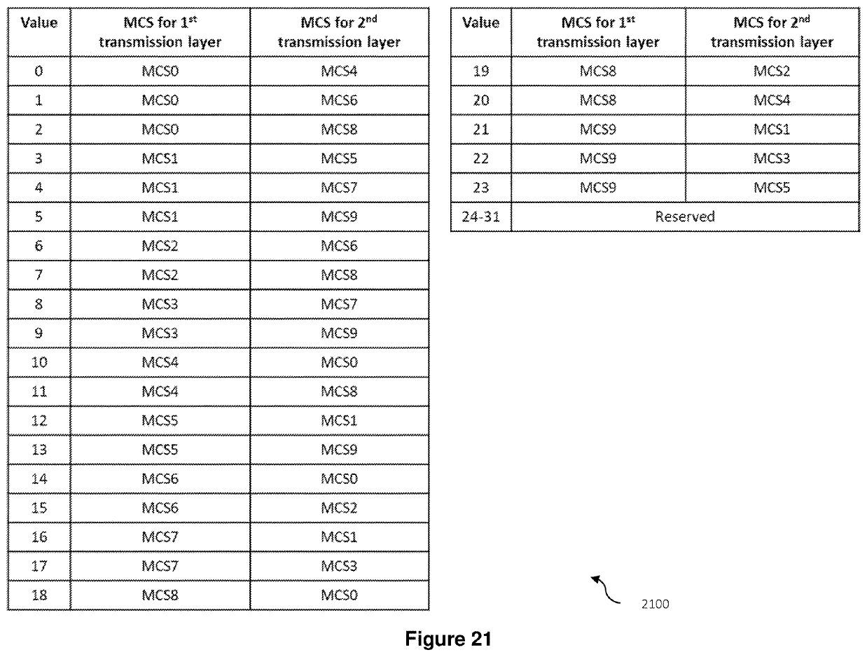

Multi-layer User Info fields together with User Info fields may be included in a trigger frame. In an implementation, a Multi-layer User Info field may be of a same size as a User Info field. FIG. 20 depicts a trigger frame 2000 including both User Info field (e.g., User Info field 2004) and Multi-layer User Info field (e.g., Multi-layer User Info field 2002) of a same size according to various embodiments of the present disclosure. Multi-layer User Info field 2002 may comprise the same subfields as that in User Info field 2004. A single set of transmit parameters indicated by UL FEC Coding Type subfield 2008, SS Allocation subfield 2014, UL Target Receive Power subfield 2016 and PS160 subfield 2018 are applied across all transmission layers. Two sets of transmit parameters may be indicated by the RU Allocation subfield 2006 (referred to herein as a fourth field) and UL UHR-MCS subfield 2010 (referred to herein as a fifth field) for two transmission layers. A Multi-layer User Info field may be specified by a UL Multi-layer Tx/UL Multi-layer Enable subfield (e.g., UL Multi-layer Tx/UL Multi-layer Enable subfield 2012 in Multi-layer User Info field 2002). In this case, the Multi-layer User Info field 2002 may be regarded as a special case of User Info field. The RU allocations for the two transmission layers may be implicitly indicated by the RU Allocation subfield 2006 using MRU allocation. Each RU in the MRU may be assigned to each layer according to a predetermined order. For example, When MRU allocation RU A and RU B is indicated by the RU Allocation subfield 2006 and UL Multi-layer Tx/UL Multi-layer Enable subfield 2012 is set to 1, RU A is the RU for the 1st transmission layer and RU B is the RU for the 2nd transmission layer (e.g., A and B is the RU index number between 1~148). Alternatively, each RU may be implicitly assigned to each layer based on the parameters of the layer such as MCS. The MCSs for the two transmission layers may be indicated by the UL UHR-MCS subfield 2010. When UL Multi-layer Tx subfield 2012 is set to 1, the UL UHR-MCS subfield 2010 (4 bits) may indicate two different MCSs for two transmission layers. Restrictions such as the range of difference between the two MCSs index can be applied to reduce number of bits. For example, it can be restricted that the two MCSs indicated in the UL UHR-MCS subfield 2010 shall not exceed MCS 9, and the difference d₁ between the two MCSs index shall satisfy 4≤d₁; the difference d₂ between the options of MCSs index for a single transmission layer shall satisfy 4≤d₂. In this case, the example encoding of the UL UHR-MCS subfield 2010 is shown in Table 2100 of FIG. 21. Thus, the non-AP STA that is addressed by the Multi-layer User Info field 2002 prepares the UL multi-layer transmission according to the multiple sets of transmit parameters indicated in the User Info field 2004.

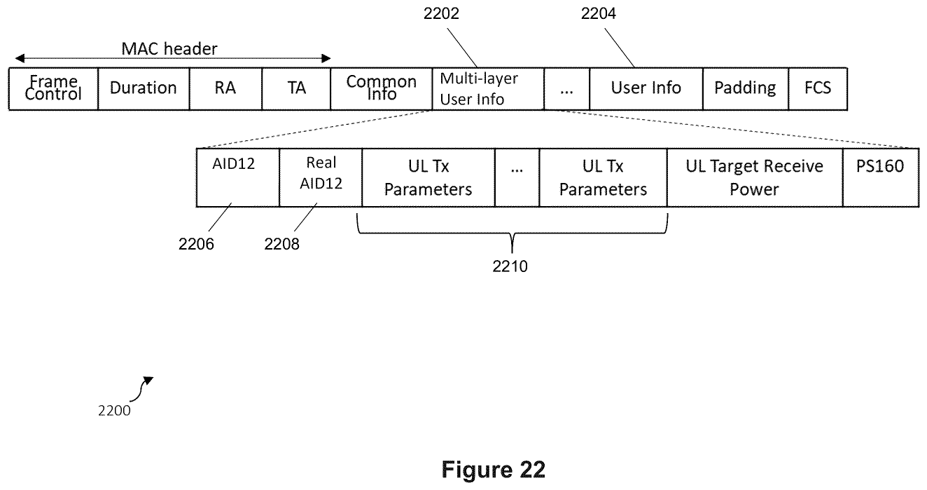

In an implementation, Multi-layer User Info fields may be included together with User Info fields in a trigger frame, such that a Multi-layer User Info field may be of a different size from a User Info field. FIG. 22 depicts a trigger frame 2200 including both User Info field (e.g., User Info field 2204) and Multi-layer User Info field (e.g., Multi-layer User Info field 2202) of different sizes according to various embodiments of the present disclosure. Multi-layer User Info field 2202 may comprise an AID12 subfield 2206, a Real AID12 subfield 2208 and multiple UL Tx Parameters subfields 2210. The Multi-layer User Info field 2202 is addressed to an associated non-AP STA whose AID is equal to the value in the Real AID12 subfield 2208. The Multi-layer User Info field 2202 may be specified by a special AID12 value of 2208 (or any value reserved for AID12 subfield in accordance with IEEE 802.11be specifications). Format and rules of the UL Tx Parameters subfields 2210 may be configured to be the same as that for UL Tx Parameters subfields 1410 and 1706 (e.g., same as that for the case when only Multi-layer User Info fields are included in the trigger frame). The size of each Multi-layer User Info field (such as Multi-layer User Info field 2202) may be flexible, and the size of a Multi-layer User Info field (such as User Info field 2204) may be indicated. For example, a Multi-layer User Info field may comprise a ‘Number of UL Tx Parameters’ subfield (such as the Number of UL Tx Parameters subfield 1704 in FIG. 17) to indicate its size, same as that for the case when only Multi-layer User Info fields are included in the trigger frame. Advantageously, more information can be contained in the Multi-layer User Info field 2202 compared to the Multi-layer User Info field 2002 (e.g., compared to the case where a Multi-layer User Info field is of the same size as a User Info field).

When a non-AP STA receives a trigger frame, if the non-AP STA is addressed by a Multi-layer User Info field in the trigger frame, the non-AP STA shall take following steps: in a non-adaptive way of processing the trigger frame, the non-AP STA prepares an UL multi-layer transmission according to the multiple sets of transmit parameters indicated in the Multi-layer User Info field; in a self-adaptive way of processing the trigger frame, the non-AP STA determines whether to transmit the UL multi-layer transmission. The non-AP STA prepares the UL transmission according to the Multi-layer User Info field if it determines not to transmit a UL multi-layer transmission. Otherwise, the non-AP STA prepares the UL multi-layer transmission according to the multiple sets of transmit parameters indicated in the Multi-layer User Info field.

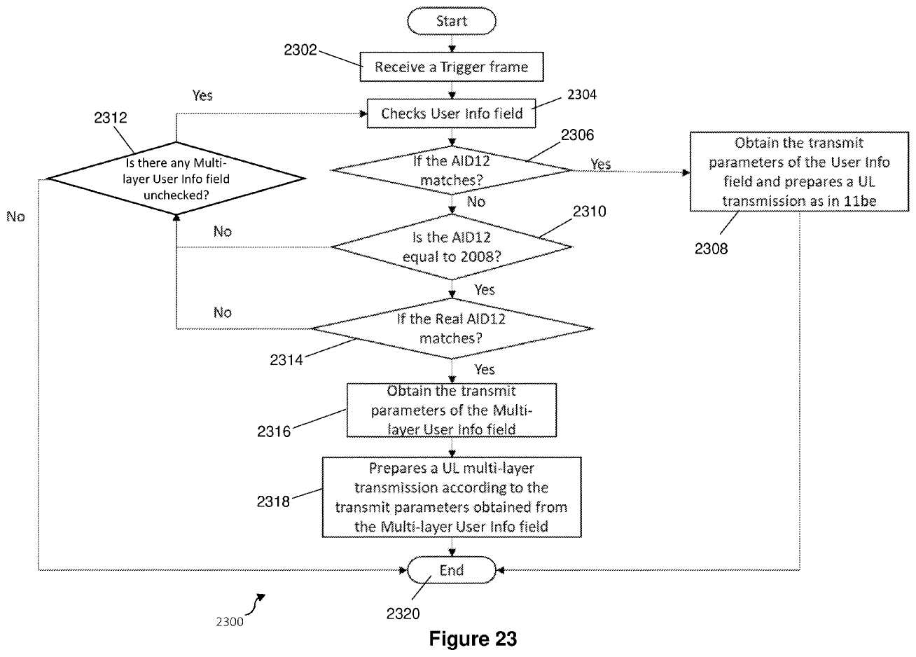

FIG. 23 depicts a flowchart 2300 for non-AP STA behavior when processing a trigger frame (e.g., trigger frame 2200 of FIG. 22) in a non-adaptive way according to various embodiments of the present disclosure. At step 2302, a non-AP STA receives a trigger frame. At step 2304, the non-AP STA checks a User Info field of the trigger frame. At step 2306, it is determined whether an AID12 of the User Info field (e.g., a value indicated in an AID12 field of the User Info field) matches with an AID associated with the non-AP STA. If it is determined that there is a match, the process proceeds to step 2308 in which the non-AP STA obtains the transmit parameters of the checked User Info field and prepares an UL transmission in accordance with the IEEE 802.11be specifications. The process then ends at step 2320. If, on the other hand, it is determined that the AID12 does not match, the process proceeds from step 2306 to step 2310 in which it is determined whether the AID12 is equal to 2008. If it is determined that the AID12 is not equal to 2008, the process proceeds to step 2312 in which it is determined whether there is any unchecked User Info field left in the trigger frame. If it is determined to be the case, the process returns to step 2304 for checking another User Info field, otherwise the process ends at step 2320.

On the other hand, if it is determined at step 2310 that the AID12 is equal to 2008, the process proceeds to step 2314 in which it is determined whether the Real AID12 (e.g., a value indicated in a Real AID12 subfield of the Multi-layer User Info field being checked) matches the AID associated with the non-AP STA. If it is determined that the Real AID12 does not match, the process proceeds to step 2312 as explained above. If it is determined that the Real AID12 matches that of the AID associated with the non-AP STA, the process proceeds to step 2316 in which the non-AP STA obtains the transmit parameters of the checked Multi-layer User Info field. At step 2318, the non-AP STA prepares an UL multi-layer transmission according to the transmit parameters obtained from the Multi-layer User Info field, and the process then ends at step 2320.

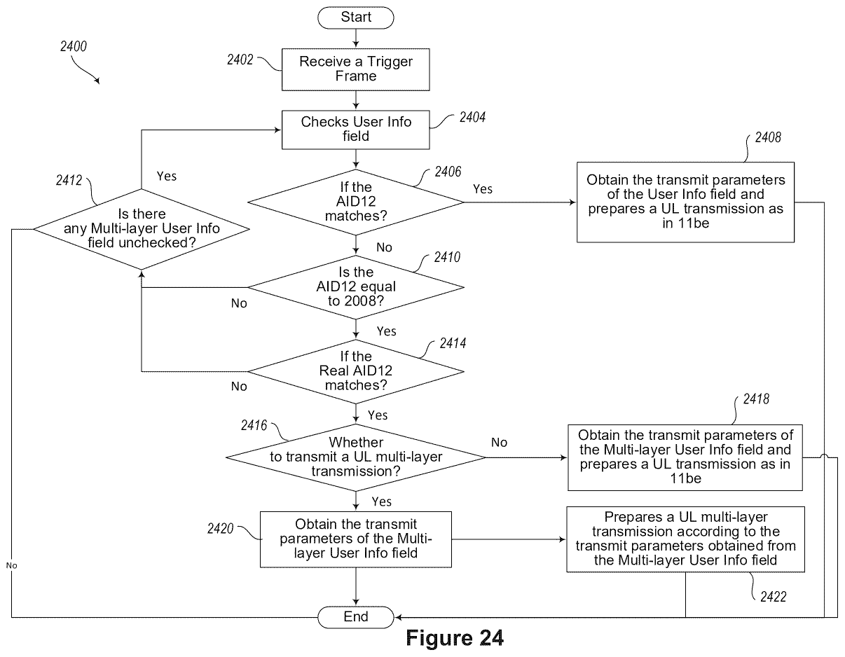

FIG. 24 depicts a flowchart 2400 for non-AP STA behavior when processing a trigger frame (e.g., trigger frame 2200 of FIG. 22) in a self-adaptive way according to various embodiments of the present disclosure. At step 2402, a non-AP STA receives a trigger frame. At step 2404, the non-AP STA checks a User Info field of the trigger frame. At step 2406, it is determined whether an AID12 of the User Info field (e.g., a value indicated in an AID12 field of the User Info field) matches with an AID associated with the non-AP STA. If it is determined that there is a match, the process proceeds to step 2408 in which the non-AP STA obtains the transmit parameters of the checked User Info field and prepares an UL transmission in accordance with the IEEE 802.11be specifications. The process then ends at step 2424. If, on the other hand, it is determined that the AID does not match, the process proceeds from step 2406 to step 2410 in which it is determined whether the AID12 is equal to 2008. If it is determined that the AID12 is not equal to 2008, the process proceeds to step 2412 in which it is determined whether there is any unchecked User Info field left in the trigger frame. If it is determined to be the case, the process returns to step 2404 for checking another User Info field, otherwise the process ends at step 2424.

On the other hand, if it is determined at step 2410 that the AID12 is equal to 2008, the process proceeds to step 2414 in which it is determined whether the Real AID12 (e.g., a value indicated in a Real AID12 subfield of the Multi-layer User Info field being checked) matches the AID associated with the non-AP STA. If it is determined that the Real AID12 does not match, the process returns to step 2412 in which it is determined again whether there is any unchecked User Info field left in the trigger frame. On the other hand, if it is determined at step 2414 that the Real AID12 matches that of the AID associated with the non-AP STA, the process proceeds to step 2416 in which the non-AP STA determines whether an UL Multi-layer transmission should be transmitted (e.g., a self-adaptive procedure). If it is determined that an UL Multi-layer transmission should not be transmitted, the process proceeds to step 2418 in which the non-AP STA obtains the transmit parameters of the Multi-layer User Info field and prepares an UL transmission in a same manner as specified in the IEEE 802.11be specifications, and the process ends at step 2424. Otherwise, the process proceeds from step 2416 to step 2420, in which the non-AP STA obtains the transmit parameters of the Multi-layer User Info field, and proceeds to step 2422 in which the non-AP STA prepares an UL multi-layer transmission according to the transmit parameters obtained from the Multi-layer User Info field, and the process ends at step 2424.

In an embodiment, when a non-AP STA transmits an UL multi-layer transmission in an UHR TB PPDU, the non-AP STA may prepare the UHR TB PPDU in a non-adaptive or self-adaptive way. In a non-adaptive way, the non-AP STA may construct the UHR TB PPDU according to transmit parameters obtained from the trigger frame. No additional signaling is needed. In a self-adaptive way, the non-AP STA may, in a first option, construct the UHR TB PPDU according to transmit parameters obtained from the trigger frame (e.g., all transmit parameters are indicated in the trigger frame). In a first case of the first option, the non-AP STA may indicate the UL multi-layer transmission by signaling in the UHR TB PPDU. In a second case of the first option, the non-AP STA may indicate the UL multi-layer transmission without signaling in the UHR TB PPDU. In a second option of processing the trigger frame in a self-adaptive way, the non-AP STA may construct the UHR TB PPDU according to partial transmit parameters obtained from the trigger frame, and transmit parameters decided by itself. (e.g., partial transmit parameters are indicated in the trigger frame). In a first case of the second option, the transmit parameters for UL multi-layer transmission may be indicated by signaling in the UHR TB PPDU. In a second case of the second option, the transmit parameters for UL multi-layer transmission may be indicated without signaling in the UHR TB PPDU.

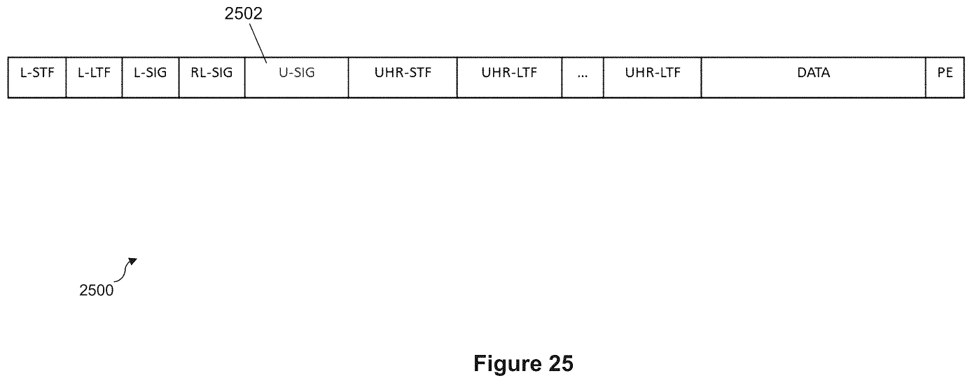

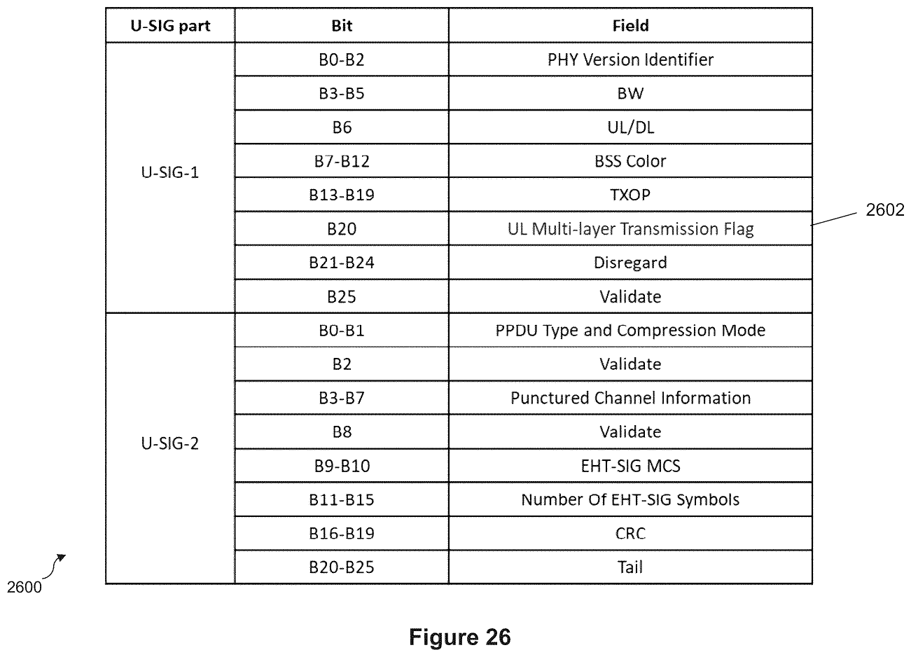

According to the first case of the first option as described above, whether the UL transmission is an UL Multi-layer transmission may be indicated in a preamble of the UL transmission. Referring to an UL transmission preamble 2500 of FIG. 25, an UL Multi-layer Transmission Flag subfield may be included in U-SIG field 2502 of the preamble 2500. This is further shown in table 2600 of FIG. 26, in which an UL Multi-layer Transmission Flag subfield 2602 may be indicated in bit B20 of U-SIG-1 of a U-SIG field (e.g., U-SIG field 2502 of the preamble 2500). An AP may be configured to decode and demodulate a UHR TB PPDU based on an indication of UL Multi-layer Transmission Flag subfield. For example, when the UL Multi-layer Transmission Flag subfield is set to 1, it is indicated that the UL transmission is an UL Multi-layer transmission transmitted by the non-AP STA. When the UL Multi-layer Transmission Flag subfield is set to 0, it is a normal UL transmission transmitted by the non-AP STA. A total RU/MRU size allocated to the non-AP STA may be integer times of 242-tone (20 MHz), so the signaling can be added to U-SIG field without affecting transmission from other non-AP STAs.

According to the second case of the first option as described above, whether the UL transmission is a UL multi-layer transmission may be identified by the AP based on a blind decoding result. In this case, no additional signaling is needed in the UHR TB PPDU. The transmit parameters indicated in the trigger frame (e.g., there are two different types of transmit parameters indicated when it is for a self-adaptive way of processing, a first type being transmit parameters for a normal UL transmission if the non-AP STA determines not to transmit a UL multi-layer transmission, and a second type being transmit parameters for an UL multi-layer transmission) may be restricted in order to reduce decoding complexity for the AP. For example, a total RU/MRU size indicated in the first type of transmit parameters for a normal UL transmission and the second type of transmit parameters for a UL multi-layer transmission may be different. The AP may identify an UL multi-layer transmission by blind decoding the occupied RU/MRU.

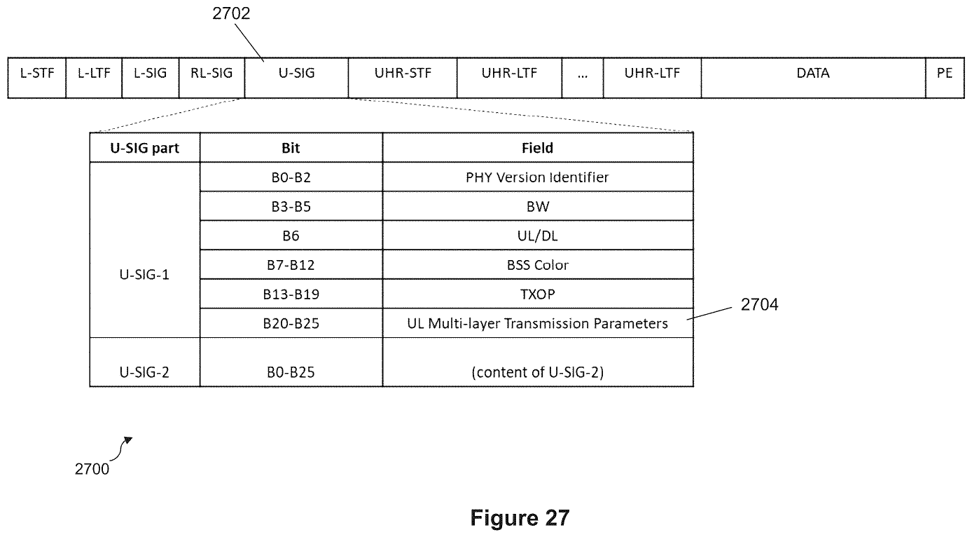

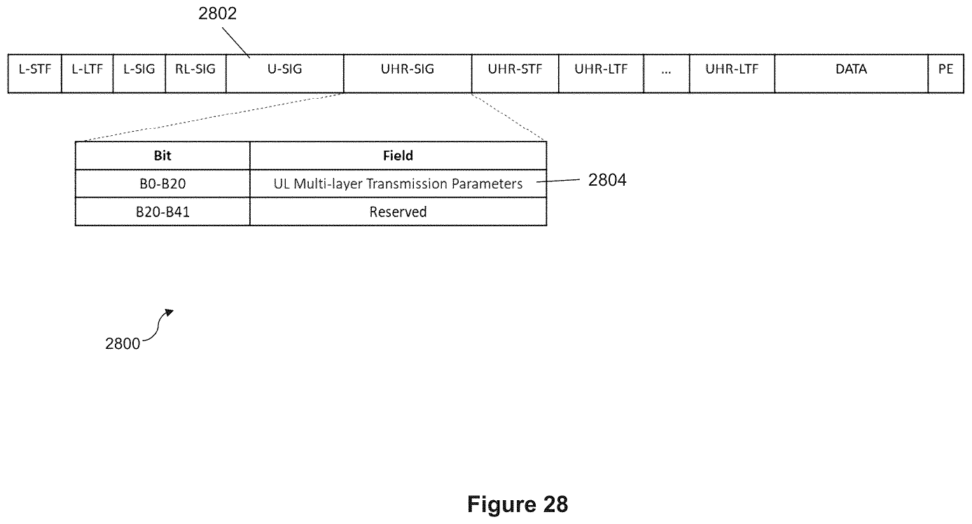

According to the first case of the second option as described above, transmit parameters for UL multi-layer transmission may be indicated by signaling in an UHR TB PPDU. For example, referring to UHT TB PPDU 2700 of FIG. 27, an UL Multi-layer Transmission Parameter subfield may be comprised in an UHR TB PPDU, as shown in UL Multi-layer Transmission Parameter subfield 2704 in U-SIG field 2702 of UHR TB PPDU 2700. In this case, the total RU/MRU size allocated to the non-AP STA may be integer times of 242-tone (20 MHz), so the signaling can be added to U-SIG field 2702 without affecting transmission from other non-AP STAs. Further referring to UHR TB PPDU 2800 of FIG. 28, UL Multi-layer Transmission Parameter subfield 2804 may alternatively be included in a new SIG field (e.g., UHR-SIG field 2802) in the UHR TB PPDU 2800. An advantage of such an implementation is that more signaling bits can be used, thus enabling more information to be indicated.

Further, according to the second case of the second option as described above, transmit parameters for UL multi-layer transmission may be identified by an AP based on a blind decoding result. No additional signaling is needed in UHR TB PPDU. The transmit parameters indicated in a trigger frame (e.g., there are two different types of transmit parameters indicated when it is for a self-adaptive way of processing, a first type being the transmit parameters for a normal UL transmission if the non-AP STA determines not to transmit a UL multi-layer transmission, and a second type being the transmit parameters for UL multi-layer transmission) may be restricted in order to reduce the decoding complexity for the AP. For example, the total RU/MRU size indicated in the first type of transmit parameters for a normal UL transmission and the second type of transmit parameters for an UL multi-layer transmission may be different. The AP may identify an UL multi-layer transmission by blind decoding the occupied RU/MRU. Further, the transmit parameters decided by a non-AP STA may be restricted in order to reduce the decoding complexity for the AP. For example, if a MCS is decided by a non-AP STA, the range of MCS that can be selected may be restricted as ‘only one MCS index can be selected for a same modulation mapping’. The AP may identify the MCS once constellation points for the MCS are detected.

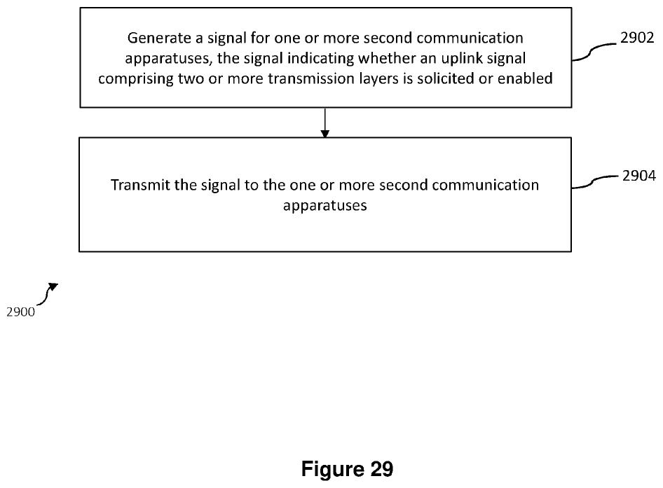

FIG. 29 shows a flow diagram 2900 illustrating a communication method according to various embodiments. At step 2902, a signal is generated for one or more second communication apparatuses, the signal indicating whether an uplink signal comprising two or more transmission layers is solicited or enabled. At step 2904, the signal is transmitted to the one or more second communication apparatuses.

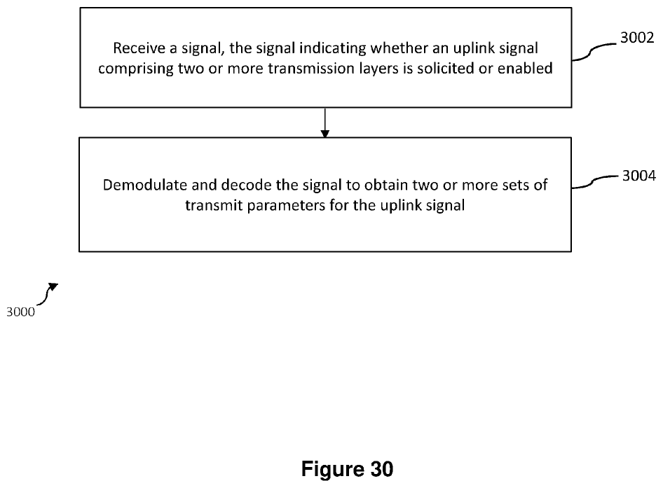

FIG. 30 shows a flow diagram 3000 illustrating a communication method according to various embodiments. At step 3002, a signal is received, the signal indicating whether an uplink signal comprising two or more transmission layers is solicited or enabled. At step 3004, the signal is demodulated and decoded to obtain two or more sets of transmit parameters for the uplink signal.

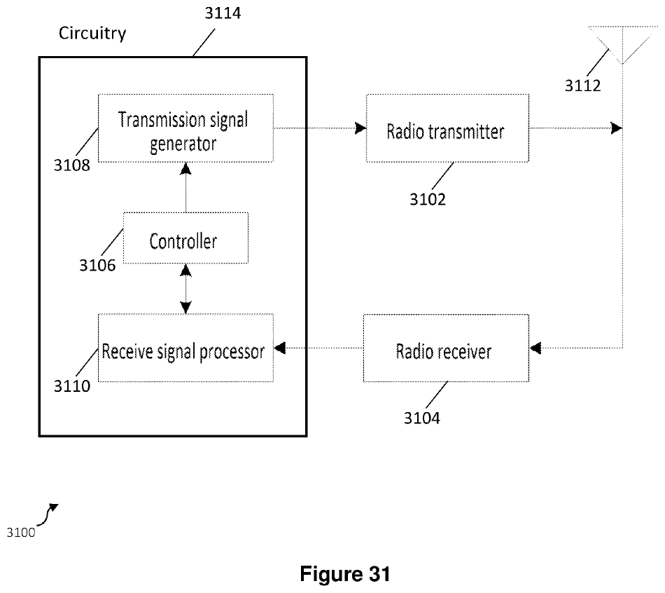

FIG. 31 shows a schematic, partially sectioned view of a communication apparatus 3100 that can be implemented for service discovery for local area network in accordance with the various embodiments. The communication apparatus 3100 may be implemented as a mobile terminal, application host, router, server, STA or AP according to various embodiments.

Various functions and operations of the communication apparatus 3100 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 31, the communication apparatus 3100 may include circuitry 3114, at least one radio transmitter 3102, at least one radio receiver 3104 and multiple antennas 3112 (for the sake of simplicity, only one antenna is depicted in FIG. 31 for illustration purposes). The circuitry may include at least one controller 3106 for use in software and hardware aided execution of tasks it is designed to perform, including control of communications with one or more other devices in a wireless network. The at least one controller 3106 may control at least one transmission signal generator 3108 for generating frames to be sent through the at least one radio transmitter 3102 to one or more other STAs or APs and at least one receive signal processor 3110 for processing frames received through the at least one radio receiver 3104 from the one or more other STAs or APs. The at least one transmission signal generator 3108 and the at least one receive signal processor 3110 may be stand-alone modules of the communication apparatus 3100 that communicate with the at least one controller 3106 for the above-mentioned functions. Alternatively, the at least one transmission signal generator 3108 and the at least one receive signal processor 3110 may be included in the at least one controller 3106. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 3102, at least one radio receiver 3104, and at least one antenna 3112 may be controlled by the at least one controller 3106. Furthermore, while only one radio transmitter 3102 is shown, it will be appreciated that there can be more than one of such transmitters.

In various embodiments, when in operation, the at least one radio receiver 3104, together with the at least one receive signal processor 3110, forms a receiver of the communication apparatus 3100. The receiver of the communication apparatus 3100, when in operation, provides functions required for processing an information container. While only one radio receiver 3104 is shown, it will be appreciated that there can be more than one of such receivers.

The communication apparatus 3100, when in operation, provides functions required for uplink multi-layer transmission. For example, the communication apparatus 3100 may be a first communication apparatus, and the circuitry 3114 may, in operation, generate a signal for one or more second communication apparatuses, the signal indicating whether an uplink signal comprising two or more transmission layers is solicited or enabled. The transmitter 3102 may, in operation, transmit the signal to the one or more second communication apparatuses.

The signal may further comprise two or more second fields indicating two or more sets of transmit parameters corresponding to the two or more transmission layers of the uplink signal respectively, the two or more second fields being addressed by a same identifier. The signal may comprise a second field indicating two or more sets of transmit parameters corresponding to the two or more transmission layers of the uplink signal. The signal may comprise a first field indicating whether the uplink signal is solicited or enabled, the first field being separate from or included in the second field or each of the two or more second fields. The indication whether the uplink signal is solicited or enabled may be based on a presence of the second field or the two or more second fields, or based on a total number of sets of transmit parameters. The second field or the two or more second fields may comprise two or more third fields indicating the two or more sets of transmit parameters for the two or more transmission layers of the uplink signal respectively. The second field or the two or more second fields may comprise a fourth field indicating a resource unit (RU) allocation information for the two or more sets of transmission layers of the uplink signal. The second field or the two or more second fields further may comprise a fifth field indicating modulation and coding scheme (MCS) information for the two or more transmission layers of the uplink signal. The second field may further comprise a sixth field indicating a size of the second field. The receiver 3104 may, in operation, receive the uplink signal comprising the two or more transmission layers from the one or more second communication apparatuses, the uplink signal being generated based on the two or more sets of transmission parameters.

The signal may comprise a first field indicating whether the uplink signal is solicited or enabled, and a second field indicating a single set of transmit parameters for an uplink signal comprising a single transmission layer. The receiver 3104 may, in operation, receive the uplink signal comprising the single transmission layer from the one or more second communication apparatuses, the uplink signal being generated based on the single set of transmit parameters.

The communication apparatus 3100 may be a second communication apparatus. The receiver 3104 may, in operation, receive a signal from a first communication apparatus, the signal indicating whether an uplink signal comprising two or more transmission layers is solicited or enabled. The circuitry 3114 may, in operation, demodulate and decode the signal to obtain two or more sets of transmit parameters for the uplink signal.

The circuitry 3114 may be configured to generate the uplink signal based on the two or more sets of transmit parameters, and the transmitter 3102 may, in operation, transmit the uplink signal to the first communication apparatus. The generated uplink signal may comprise a field to indicate whether the generated uplink signal comprises two or more transmission layers.

The signal may indicate that the uplink signal comprising the two or more transmission layers is enabled, and the circuitry 3114 may be further configured to: obtain, from the signal, a single set of transmit parameters for an uplink signal comprising a single transmission layer; determine whether to generate an uplink signal comprising a single transmission layer based on the single set of transmit parameters, or generate an uplink signal comprising two or more transmission layers based on the two or more sets of transmit parameters; and generate the uplink signal based on the determination.

The present disclosure can be realized by software, hardware, or software in cooperation with hardware. Each functional block used in the description of each embodiment described above can be partly or entirely realized by an integrated circuit (IC) such as LSI (Large Scale Integration), and each process described in each embodiment may be controlled partly or entirely by a same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, an ultra-LSI, a very-large-scale integration (VLSI), or a system on a chip (SoC) depending on the integration scales. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing and/or analogue processing. The functional blocks could be integrated with various integrated circuit technologies which are not limited to those mainly used at present. Biotechnology can also be applied.

The present disclosure can be realized by any kind of apparatus, device or system having a function of communication, which is referred to as a communication apparatus.

Some non-limiting examples of such communication apparatus may include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device, head mounted display (HMD), smart glasses), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication apparatus performing a function of communication described in the present disclosure. For example, the communication apparatus may comprise a controller or a sensor that generates control signals or data signals which are used by a communication apparatus performing a communication function of the communication apparatus.

The communication apparatus also may include an infrastructure facility, such as a base station, an access point, and any other apparatus, device or system that communicates with or controls apparatuses such as those in the above non-limiting examples.

Thus, it can be seen that the present embodiments provide communication apparatuses and methods for uplink multi-layer transmission.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A first communication apparatus comprising:
circuitry, which in operation, generates a signal for one or more second communication apparatuses, the signal indicating whether an uplink signal comprising two or more transmission layers is solicited or enabled; and
a transmitter, which in operation, transmits the signal to the one or more second communication apparatuses.

2. The first communication apparatus of claim 1, wherein the signal further comprises two or more second fields indicating two or more sets of transmit parameters corresponding to the two or more transmission layers of the uplink signal respectively, the two or more second fields being addressed by a same identifier.

3. The first communication apparatus of claim 1, wherein the signal comprises a second field indicating two or more sets of transmit parameters corresponding to the two or more transmission layers of the uplink signal.

4. The first communication apparatus of claim 2, wherein the signal comprises a first field indicating whether the uplink signal is solicited or enabled, the first field being separate from or included in the second field or each of the two or more second fields.

5. The first communication apparatus of claim 2, wherein the indication whether the uplink signal is solicited or enabled is based on a presence of the second field or the two or more second fields, or based on a total number of sets of transmit parameters.

6. The first communication apparatus of claim 2, wherein the second field or the two or more second fields comprise two or more third fields indicating the two or more sets of transmit parameters for the two or more transmission layers of the uplink signal respectively.

7. The first communication apparatus of claim 2, wherein the second field or the two or more second fields comprise a fourth field indicating a resource unit (RU) allocation information for the two or more sets of transmission layers of the uplink signal.

8. The first communication apparatus of claim 2, wherein the second field or the two or more second fields further comprise a fifth field indicating modulation and coding scheme (MCS) information for the two or more transmission layers of the uplink signal.

9. The first communication apparatus of claim 3, wherein the second field further comprises a sixth field indicating a size of the second field.

10. The first communication apparatus of claim 2, further comprising a receiver, which in operation, receives the uplink signal comprising the two or more transmission layers from the one or more second communication apparatuses, the uplink signal being generated based on the two or more sets of transmission parameters.

11. The first communication apparatus of claim 1, wherein the signal comprises a first field indicating whether the uplink signal is solicited or enabled, and a second field indicating a single set of transmit parameters for an uplink signal comprising a single transmission layer.

12. The first communication apparatus of claim 11, further comprising a receiver, which in operation, receives the uplink signal comprising the single transmission layer from the one or more second communication apparatuses, the uplink signal being generated based on the single set of transmit parameters.

13. A second communication apparatus comprising:
a receiver, which in operation, receives a signal from a first communication apparatus, the signal indicating whether an uplink signal comprising two or more transmission layers is solicited or enabled; and
circuitry, which in operation, demodulates and decodes the signal to obtain two or more sets of transmit parameters for the uplink signal.

14. The second communication apparatus of claim 12, wherein the circuitry is configured to generate the uplink signal based on the two or more sets of transmit parameters, the second communication apparatus further comprising a transmitter, which in operation, transmits the uplink signal to the first communication apparatus.

15. The second communication apparatus of claim 12, wherein the signal indicates that the uplink signal comprising the two or more transmission layers is enabled; and the circuitry is further configured to:
obtain, from the signal, a single set of transmit parameters for an uplink signal comprising a single transmission layer;
determine whether to generate an uplink signal comprising a single transmission layer based on the single set of transmit parameters, or generate an uplink signal comprising two or more transmission layers based on the two or more sets of transmit parameters; and
generate the uplink signal based on the determination.

16. The second communication apparatus of claim 14, wherein the generated uplink signal comprises a field to indicate whether the generated uplink signal comprises two or more transmission layers.

17. A communication method comprising:
generating a signal for one or more communication apparatuses, the signal indicating whether an uplink signal comprising two or more transmission layers is solicited or enabled; and
transmitting the signal to the one or more communication apparatuses.

18. A communication method comprising:
receiving a signal, the signal indicating whether an uplink signal comprising two or more transmission layers is solicited or enabled; and
demodulating and decoding the signal to obtain two or more sets of transmit parameters for the uplink signal.
